(19) United States
(12) Patent Application Publication
(10) Pub. No.: US 2022/0122458 A1
(43) Pub. Date: Apr. 21, 2022

(54) METHOD AND SMART PARKING SYSTEM USING INTELLIGENT PLUG-AND-PLAY POINT TO MULTIPOINT INTERNET of THINGS (IoT) PLATFORM

(71) Applicants: BANG TRAN DAO, Binh Dinh (VN); LONG HONG LE, BINH DINH (VN); HAU VAN HUYNH, Tien Giang (VN); CANH HUU NGUYEN, Ho Chi Minh (VN); SON GIANG LAM, Ho Chi Minh (VN)

(72) Inventors: BANG TRAN DAO, Binh Dinh (VN); LONG HONG LE, BINH DINH (VN); HAU VAN HUYNH, Tien Giang (VN); CANH HUU NGUYEN, Ho Chi Minh (VN); SON GIANG LAM, Ho Chi Minh (VN)

(73) Assignee: EoH Joint Stock Company, HO CHI MINH (VN)

(21) Appl. No.: 17/646,712

(22) Filed: Dec. 31, 2021

Related U.S. Application Data
(63) Continuation-in-part of application No. 17/068,952, filed on Oct. 13, 2020.

(51) Int. Cl. G08G 1/14; G06Q 20/02; G08G 1/017; G16Y 10/40; G16Y 20/20; G06Q 10/02; H04N 5/232; G01C 21/00; G01C 21/36; G06F 3/0482

(52) U.S. Cl. CPC G08G 1/142; G06Q 20/027; G08G 1/0175; G16Y 10/40; G16Y 20/20; G06F 3/0482; H04N 5/232; G01C 21/3833; G01C 21/3626; G01C 21/3807; G06Q 10/02

(57) ABSTRACT

A smart parking system and method are disclosed which includes a plug-and-play and point to multipoint (PnP&P2MP) based internet of things (IoT) parking sensors, gateway managers, and user devices that can share information via a network. The information is used to preserve parking spaces, calculate minimum parking search time, and establish a dynamic queuing system to achieve high throughput, avoid traffic congestion and time losses.

### CLAIM OF PRIORITY

This application is a continuation-in-part application under 35 U.S.C. § 120 of application Ser. No. 17/068,952, entitled “Intelligent Plug-and-Play Point-to-Multipoint Internet of Things (Iot) Platform and Method of Managing and Using the Same”, filed on Oct. 13, 2020. The parent application is incorporated herewith in its entirety for references.

### FIELD OF THE INVENTION

The present invention relates generally to an Internet of Things (IoT) platform. More specifically, the present invention relates to an Internet of Things (IoT) platform applicable to a smart parking environment.

### BACKGROUND ART

The Covid-19 pandemic caused 200 billion usd of 2025 global revenue loss to the IoT-based industry. However, more than 84% of IoT users still believe that more wireless IoT connectivities should be adopted. As a result, the number of IoT devices that are active is expected to grow to 83 billion by 2024. This will pave the way for smart cities including smart parking.

Urbanization is expanding, and traffic in mega cities is becoming heavier. By 2050, the majority of 68% population growth will live in cities, worsening the parking problems and traffic congestion. Parking problems are caused by three main components: (a) the incoming traffics, (b) the limited number of available parking spaces, and (c) the lack of information. An increasing number of cities suffer from traffic congestion and time losses due to the lack of parking spaces. It is estimated that in peak hours, drivers in large cities such as Ho Chi Minh City, Vietnam, have to circle around for about more than 30 minutes to find a place where they can leave their vehicles. Many commercial parking systems have been proposed to provide more parking spaces. ParkPlus is working on deploying a fully automate parking garage in the Western United States through Boulder's mixed-use development. The company's automated parking system uses lasers to scan cars and a robotic vale to park the vehicles. Vehicles are transported by a robotic dolly that lifts and transfer them to storage racks. Using this system, up to 4 times as many cars can be parked in the same amount of space as a traditional garage. This automatic parking is expected to deliver vehicles within 3-5 minutes of a retrieval request. However, this ParkPlus's automated parking only solves the problems of inadequate parking spaces. It does not proactively solve the problems of incoming vehicles, which causes traffic congestion and costly delays.

In another approach, sensor technologies include IoT cameras, IoT sensors, wireless communications, data analytics, induction loops, smart parking meters, and advanced algorithms are deployed to solve the parking problems. However, these IoT based solutions only provide internet-connected gates, meteres, and handhelds as well as share data via application programming interface (API). In these prior-art parking solutions, parking operators use this data to direct parking enforcement.

In many IoT smart parking solution, distance sensors detect whether a parking space is taken or free. This information can be viewed by motorists using a web application. At the present, these IoT-based smart parking systems only provide parking preservation, automatic payment, automatic number plate recognition (ANPR), digital guidance signage, and smart parking mobile app called Tessera that is powered by Google Map. However, the described smart parking package offered by the Smart Parking company is only designed to provide parking solutions for IoT sensors installed by the same company only (distance sensors HC-SR04 and microprocessor ESP8266). In situation where parking lots are managed by different companies which use different sensors and gateways with different parameters and industrial standards, the smart parking by the Smart Parking Company does not address. Furthermore, the prior-art smart parking cannot deal with situations where demands for parking spaces vary dramatically during the day. For example, during major national holidays such as New Year eve, national Independence Day on the Second of September, the demands for parking spaces in downtown Ho Chi Minh City increases drastically in comparison to previous days. In such situation, the best the prior-art smart parking can offer is to show no parking available in parking areas administered by the same Smart Parking Company only. It cannot provide a prior parking information to the frustrating motorists regarding availability in other parking lots managed by different companies in the same downtown area. This is because the prior-art smart parking system does not have a plug-and-play point to multipoint (PnP&P2MP) IoT ecosystem disclosed in a U.S. Pat. No. 10,805,155.

Therefore what is needed is a smart parking system that can facilitate the decentralized point to multiple communication among IoT parking sensors.

What is needed is a smart parking system that can provide parking preservation, contactless payments, parking availability, direction guidance to motorists to different parking environments which use different IoT parking sensors.

In addition, what is needed is an IoT gateways and servers, when connected, that can provide plug-and-play and point-to-multipoint communication to any existing IoT parking sensors, hubs, gateways, and other IoT devices regardless of their manufacturers, industrial standards, physical connections, and communication protocols so that current parking situation can be shared among drivers and potential traffic congestion can be averted. This is accomplished by using the shared parking information and queueing parking model to quickly move the searching drivers to their parking spaces, thus minimizing the circling around in search for parking and the total number of vehicles on the roads—factors that cause parking congestions.

Furthermore, what is needed is a smart parking system that can dynamically solve any parking situation using information gathered from different IoT devices from different parking lots managed by different companies.

Yet what is needed is a smart parking system and method that can provide maximum throughput, minimum parking search time, and zero traffic congestion for any parking complexities using queueing models that reflect the current parking situation.

The IoT smart parking environment and accompanying software program of the present invention provides technology provide solutions for the above needs.

### SUMMARY OF THE INVENTION

Accordingly, an object of the present invention is to provide An IoT parking environment that can achieve plug-and-play and point to multipoint communication for all IoT devices, IoT agents regardless of their industrial standards, physical connections, and communication protocols.

Another object of the present invention is to provide achieve the IoT parking environment, the IoT gateway and IoT server of the present invention are capable of rendering such IoT parking environment into a plug-and-play and point-to-multipoint communication IoT parking environment.

An object of the present invention is to provide a plug-and-play and point-to-multipoint platform that can provide real-time data of all parking information for the parking environment to increase the data analytics capability that can build a parking queueing model for a smart parking system and method that are based on minimal waiting time (WQ) and maximum throughput that can avoid traffic congestions.

Another object of the present invention is to provide a smart parking system and method that include a plug-and-play and point to multipoint (PnP&P2MP) based internet of things (IoT) parking sensors, gateway managers, and user devices that can share information via a network. The information is used to preserve parking spaces, calculate minimum parking search time, and establish a dynamic queuing system to achieve high throughput, avoid traffic congestion and time losses.

An object of the present invention is to provide an Internet of Things (IoT) platform which includes: a network; a plurality of IoT servers coupled together and serviced by the network; a plurality of IoT agents coupled to each other and to the plurality of IoT servers; and a plurality of IoT devices electrically coupled to the plurality of IoT agents, wherein the IoT servers and the IoT agents of the present invention are operable to configure a plug-and-play and point to multipoint communication environment where the plurality of IoT devices, the plurality of IoT servers, and the plurality of IoT agents communicate with one another in a plug-and-play manner and in a point to multipoint manner regardless of their physical connections, industrial standards, and communication protocols.

Another object of the present invention is to provide a method of achieving a plug-and-play point to multiple point communication between a plurality of IoT devices, a plurality of IoT agents, and a plurality of IoT servers regardless of their physical connections, industrial standards, and communication protocols. The method comprises:
(a) detect a physical connection for each of the plurality of IoT devices, a plurality of IoT agents, and a plurality of IoT servers;
(b) detect a communication protocol for each of the plurality of IoT devices, a plurality of IoT agents, and a plurality of IoT servers;
(c) establish a plug-and-play communication with the plurality of IoT devices, a plurality of IoT agents, and a plurality of IoT servers based on said physical connection, said industrial standards, and said communication protocols;
(d) determine whether each of the plurality of IoT devices, the plurality of IoT agents, and the plurality of IoT servers is incorporated in a control webapp, if the plurality of IoT devices, the plurality of IoT agents, and the plurality of IoT servers are included the control webapp, then
(e) use the control webapp to create a point to multipoint communication and plug-and-play environment for the plurality of IoT devices, the plurality of IoT agents, and said plurality of IoT servers;
(f) if any of the plurality of IoT devices, the plurality of IoT agents, and the plurality of IoT servers is not included in the control webapp, detect their operating parameters, their communication protocols, and their industrial standards;
(g) create configuration files for each of the plurality of IoT devices, the plurality of IoT agents, and the plurality of IoT servers based on said said operating parameters, the communication protocols, and the industrial standards;
(h) embed the configuration files and load said said operating parameters, the communication protocols, and the industrial standards into said control webapp, and
(i) perform the step of using the control webapp to create the point to multipoint manner and in the plug-and-play manner.

Yet another aspect of the present invention is to provide an IoT agent/server for managing an IoT environment all connected together and serviced by a network; the IoT environment comprising pre-existing a plurality of IoT devices, pre-existing IoT agents, and pre-existing IoT servers. The IoT agent/server includes:
a configuration module configured to form and manage a control webapp;
a data handler module configured to manage and convert data and commands from the pre-existing IoT devices, a plurality of IoT agents, and a plurality of IoT servers;
an artificial intelligence and machine learning module configured to perform data analysis and predict operation behaviors of all IoT devices;
a device manager module to manage the plug-and-play and point to multipoint communications for all IoT devices by creating virtual nodes between said IoT agent and said plurality of IoT devices as soon as said plurality of IoT devices are first electrically coupled to and detected by said at least one IoT agents.

All the above aspects of the present invention achieve the following features and objectives:

An IoT environment that can achieve plug-and-play and point to multipoint (PnP&P2MP) communication for all IoT devices, IoT agents regardless of their industrial standards, physical connections, and communication protocols.

After connected to any pre-existing IoT environment, the IoT agent and IoT server of the present invention are capable of rendering such pre-existing IoT environment into a plug-and-play and point-to-multipoint communication IoT environment.

A plug-and-play and point-to-multipoint (PnP&P2MP) platform that can provide real-time data for all IoT devices connected thereto to increase the data analytics capability and artificial intelligence/machine learning to accurately predict the behaviors of users.

These and other advantages of the present invention will no doubt become obvious to those of ordinary skill in the art after having read the following detailed description of the exemplary embodiments, which are illustrated in the various drawing Figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a schematic diagram of a parking environment including a network, IoT servers, IoT agents (agents), and different IoT parking devices in accordance with an exemplary embodiment of the present invention;

FIG. 2 is a schematic diagram of IoT servers including pre-existing IoT servers, a sub-network, and the inner structure of a plug-and-play IoT server of the pres in accordance with an exemplary embodiment of the present invention;

FIG. 3 is a schematic diagram of an IoT parking gateways capable of point to multi-point communicating with various IoT parking devices in a plug-and-play manner in accordance with an embodiment of the present invention;

FIG. 4 is a flow chart illustrating a process of providing a plug-and-play point-to multipoint communication for various IoT parking devices in a IoT parking environment in accordance with an exemplary embodiment of the present invention;

FIG. 5 is a flow chart illustrating a method of establishing a point to multipoint communication between IoT parking devices, IoT parking gateways, and IoT servers within any parking environment using a control webapp in accordance with an exemplary embodiment of the present invention;

FIG. 6 is a perspective view of a configurable webapp configured to provide plug-and-play and point to multipoint communication (PnP&P2MP) applicable to a IoT-based parking environment in accordance with an exemplary embodiment of the present invention;

FIG. 7 is a perspective diagram depicting an exemplary parking environment;

FIG. 8 is a perspective diagram illustrating the structure of a section of an individual parking lot, a portion of the parking environment illustrated in FIG. 7, equipped with a PnP and P2MP communication based smart parking system capable of sharing parking information with other parking lots in accordance with an exemplary embodiment of the present invention;

FIG. 9 is a schematic diagram of a smart parking system capable of plug-and-play and point to multipoint communication (PnP and P2MP) with one anther in order to reduce time losses and traffic congestion in accordance with an exemplary embodiment of the present invention;

FIG. 10 is a schematic diagram of a queuing engine responsible for modeling any parking situation in order to achieve maximum throughput, minimum parking searching time, and minimum traffic congestion in accordance with an exemplary embodiment of the present invention;

FIG. 11 is a diagram illustrating a multiserver queuing system modelled after the parking environment of FIG. 7 by the smart parking system in accordance with an exemplary embodiment of the present invention;

FIG. 12 is a flow chart of a method for a smart parking environment capable of gathering parking information from different parking lots in accordance with an exemplary embodiment of the present invention;

FIG. 13 is a flow chart of a method for a local smart parking in accordance with an exemplary embodiment of the present invention; and

FIG. 14 is perspective diagram of a smart parking control webapp in accordance with an exemplary embodiment of the present invention.

The figures depict various embodiments of the technology for the purposes of illustration only. A person of ordinary skill in the art will readily recognize from the following discussion that alternative embodiments of the structures and methods illustrated herein may be employed without departing from the principles of the technology described herein.

### DETAILED DESCRIPTION OF THE INVENTION

Reference will now be made in detail to the exemplary embodiments of the invention, examples of which are illustrated in the accompanying drawings. While the invention will be described in conjunction with the exemplary embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

As used herein, the term “pre-existing”—also pre-linked or pre-connected—refers to the connections at time t−1 before the present connection at time t.

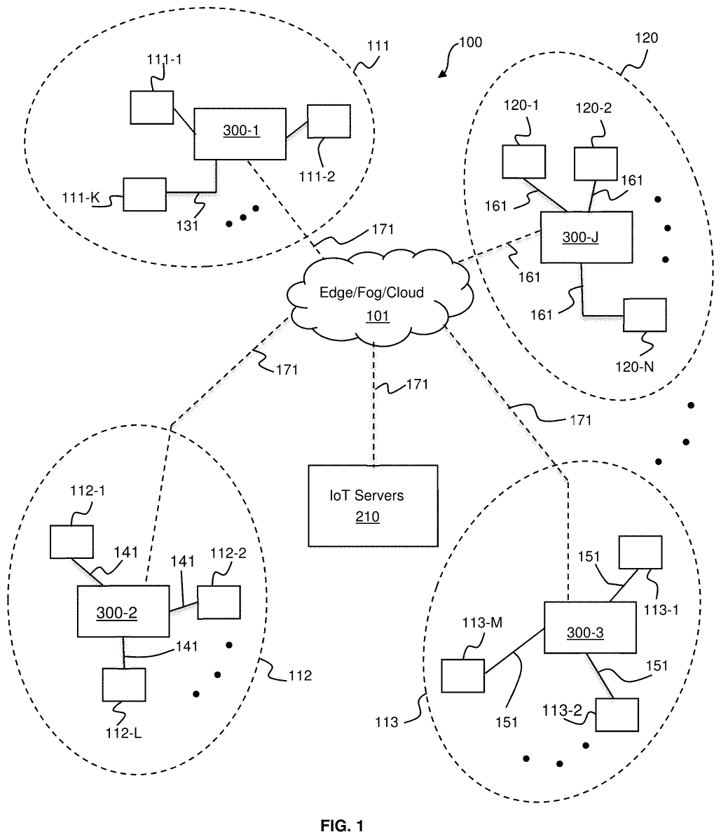

Various aspects of the present invention are now described with reference to FIG. 1-FIG. 14. FIG. 1 illustrates a schematic diagram of a plug-and-play point to multipoint (PnP&P2MP) IoT communication system 100 (“system 100”) that includes a network 101, IoT servers 200, IoT gateways 300-1 to 300-N, first IoT integration group 111, second IoT integration group 112, a third integration group 113, and J^{th} IoT integration group 120 of IoT devices in accordance with an exemplary embodiment of the present invention. First integration group 111 includes IoT devices 111-1, 111-2 . . . , 111-K connected to an IoT gateway 300-1 via a first local communication channel 131. Second integration group 112 includes IoT devices 112-1, 112-2 . . . , 112-L connected to an IoT gateway 300-2 via a second local communication channel 141. Third integration group 113 includes IoT devices 113-1, 113-2 . . . , 112-M connected to an IoT gateway 300-3 via a third local communication channel 151. J^{th} integration group 120 includes IoT devices 120-1, 120-2 . . . , 120-N connected to a J^{th} IoT gateway 300-J via a Jth local communication channel 161. In some embodiments of the present invention, first to J^{th} local communication channels 131-161 can be different for different IoT devices manufactured by different manufacturers. In other embodiments, first to fourth local communication channels 131-161 can be the same. First to fourth local communication channels 131-161 can be either wireless channels such as Bluetooth, 4G, LTE, 5G, Wi-Fi, Zigbee, Z-wave, radio frequency (RF), Near Field Communication (NFC), or wired such as RS-232, RS-485, USB, or any combinations thereof.

Continuing with FIG. 1, as non-limiting examples, first integration group 111 can be a first smart parking arrangement on a first location. Second integration group 112 can be a second smart parking arrangement on a second location different from the first location. Third integration group 113 can be a third parking arrangement on a third location different from the first and second parking Yet, J^{th} integration group 120 is a fourth smart parking arrangement located on a fourth location different from other parking arrangements respectively. In another illustrating example, first integration group 111 can be a first smart city, second integration group 112 can be a second smart city, and third integration group 113 is a third smart city, and J^{th} integration group 120 is a fourth smart city (where J=4), all including different parking arrangements. System 100 of the present invention is configured to manage the point to multiple point (P2MP) communications and operations of IoT devices 111-1 to 120-N in J^{th} different integration groups 111-120, where J is nonzero positive integer (∀J ∈ I⁺). With such extensive P2MP communication between IoT devices 111-1 to 120-N and the complexities of the real world, the demands for speed, bandwidth, and power consumption can be prohibitive. In such situation, system 100 of the present invention includes a deep reinforcement neural network (DRNN) configured to execute a set of connectivity action {aₜ} according to a given policy πᵢ as a function of transmission rate, bandwidth, and power consumption (or network reliability). Policy Pᵢ is associated with a value Q-function which is an expected aggregate future reward IoT agents (agents) 300-1 to 300-J in state Sₜ can receive by executing an action map {aₜ}. IoT server 200 and/or IoT agents 300-1 to 300-J are equipped with deep reinforcement algorithms that learn from previous connectivity actions {aₜ}, measure the reward Rₜ, Qₜ(s, a) function, and execute the next action {aₜ₊₁} to achieve optimal policy using policy gradient. Reward Rₜ includes network reliability (efficient aggregate power consumption of the whole system), transmission rate, and/or bandwidth efficiency. That is, system 100 with deep reinforcement network increases the probability of actions {aₜ} that resulted in high cumulative reward Rₜ. On the contrary, system 100 increases the probability of connectivity actions aᵢ that resulted in high reward Rₜ in the next iterative round. Within the present invention, the cumulative reward Rₜ is defined as Rₜ=Σₜ^{T} γ^{t} rₜ; where is a discount factor and its value range is [0, 1], and rₜ is defined as

$$r ( {S}_{t} , {a}_{t} ) = \{ \begin{matrix}{r}_{a} & if {\sum }_{i} {P}_{i} \leq {P}_{th} \\ - {R}_{b} , & otherwise\end{matrix} ;$$

that is if the total power consumption for an action map {aₜ}. selected by DRNN is within the threshold power consumption, then a positive reward Rₐ is given; otherwise a negative reward R_{b} is given.

Continuing with FIG. 1, in many aspects of the present invention, the agents of the deep reinforcement neural network (DRNN) inside system 100 may also situate inside the gateways IoT agents 300-1 to 300-J. In reinforcement learning, the location of agents are also important. For example, in smart parking environment, the agents must be located within each parking lot. In the present invention, IoT gateways 300-1 to 300-J are placed inside each parking structure to control the parking actions {aₜ}, of IoT devices, e.g., 111-1 to 120-N. In other embodiments of the present invention, a broadband 5G or GTE base transmit station (BTS) is used with IoT gateways 300-1 to 300-J. When either transmission rate, bandwidth, and power consumption rewards are feedback in the observation, deep reinforcement neural network of system 100 puts some of IoT devices 111-1 to 120N in queue, storing their communication into a buffer memories, executing communication requests in batch, changing the state Si, parking action {aₜ}, cumulative reward Rₜ in the direction of descending policy gradient until the transmission rate, bandwidths, and power consumption requirements are met. The detailed of the deep reinforcement algorithms is described in a copending patent application entitled, “Method and Deep Reinforcement Neural Network (DRNN) Management System for an Intelligent Plug-and-Play Point-to-Multipoint Internet of Thing Platform, filed on Dec. 31, 2021, which is incorporated in its entirety herewith for reference.

It will be noted that IoT platform 100 of the present invention is designed to operate in case of sequentially connected IoT devices of different manufacturers and operation standards. More particularly, a group of m IoT devices of 111-1 to 120-N can be pre-existing, i.e., pre-linked or pre-connected to system 100 before the other newly connected (K+L+M+N−m) IoT devices. Alternatively, m IoT devices can be newly connected as compared to previously connected (K+L+M+N−m) IoT devices, where 0<m<K+L+M+N. That is, different set of IoT devices may be connected to network 101 before or after other set of IoT devices. For example, a newly built parking lot equipped with IoT devices and gateways may be connected to the network after other parking lots in the vicinity. Additionally, these IoT devices that are connected to network 101 either before or after other IoT devices are made by different manufacturers having different physical connections, communication protocols, industrial standards, as well as operating parameters from those in first integration group 111 of the present invention. IoT devices 111-1, 111-2, . . . , 111-K in first integration group 111; IoT devices 112-1, 112-2, . . . ,112-L in second integration group 112; IoT devices 113-1, 113-2, . . . , 112-M in third integration group 112; and IoT devices 120-1, 120-2, . . . , 120-N in J^{th} integration group 120 can be distance sensors connected to detect the occupancy of a particular parking space. IoT gateways 300-1, 300-2, and 300-J can be made by different managers with different physical connections, communication protocols, operating parameters and functionalities that are used by different parking lot owners. These IoT sensors may have different operating principles such infrared (IR), radio frequency (RF), ultrasonic, electromagnetic field, etc. Network 101 can be data center, edge/fog/cloud, or network such as nanonetwork, body area network (BAN), personal area network (PAN), local area network (LAN), campus/corporate area network (CAN), metropolitan area network (MAN), wide area network (WAN), and mesh area networks, LoRaWANT protocol, low power WAN (LPWAN), or any combinations thereof.

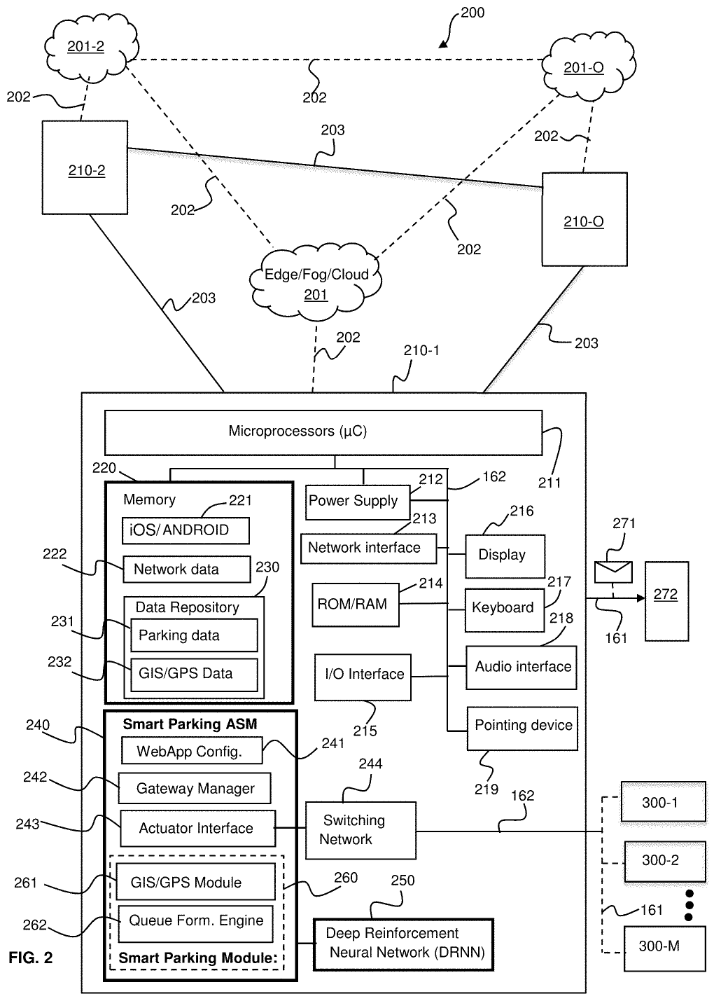

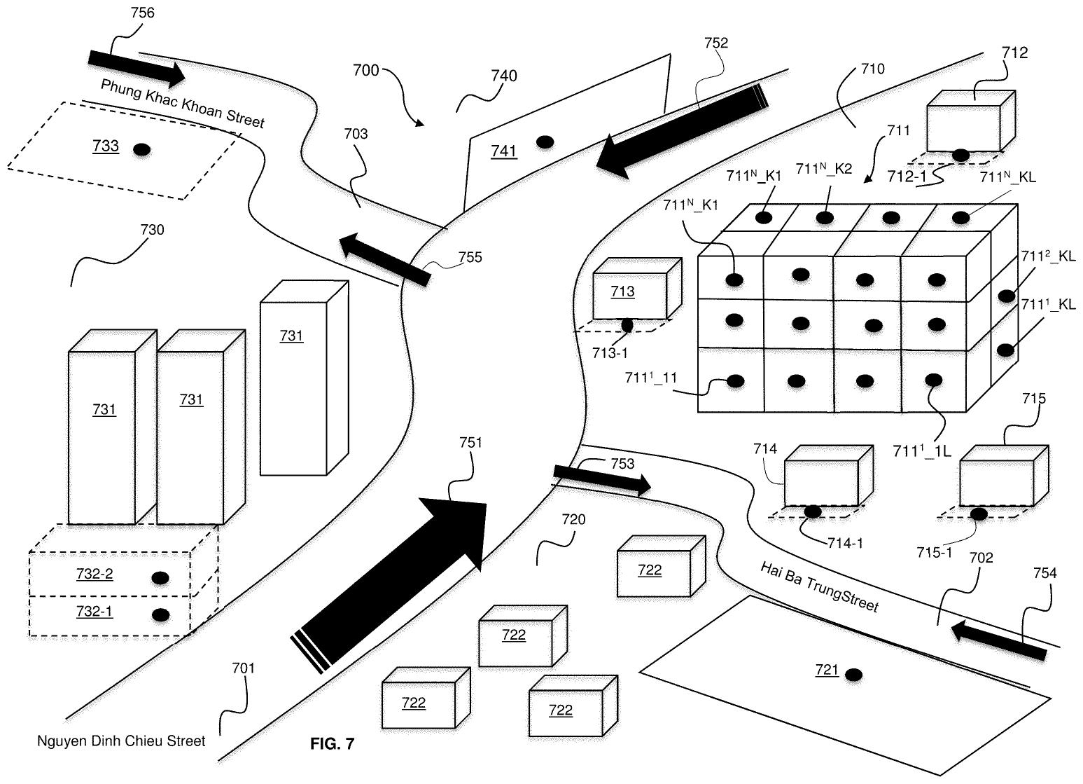

Still referring to FIG. 1, in various embodiments of the present invention, in addition to the deep reinforcement neural network, server 200 is also equipped with a smart parking module configured to resolve any complex parking situation in the entire city regardless of parking lot ownership who may use different type of IoT protocols. With PnP&P2MP communication capability, smart parking module (shown in FIG. 2) connects different parking environments operated by different owners in a wide area, spanning across many districts or the entire city, that is interconnected with public transportation that deliver convenience to motorists and reduce traffic conditions under any kind of parking situations. More particularly, IoT gateways 300-1 to 300-J immediately establish PnP&P2MP connections to exchange parking information among IoT sensors, 112-1 to 120-N, in the wide area inclusive of public transportation. Manager 200 uses the exchanged parking information to guide batch of arriving motorists to the nearest available parking lots in a fashion that achieves maximum throughput (thus avoiding traffic congestion) and minimal searching time (providing convenience to motorists). The details operation of the smart parking module will be disclosed in FIG. 7 to FIG. 14.

As shown in FIG. 1, regardless of the physical structures, manufacturers industrial standards, operating parameters, communication protocols, and geographical locations, IoT gateways 300-J and IoT servers 200 of the present invention are operable to achieve the following objects of the present invention:

(1) Plug-and-play and point-to-multipoint communication (PnP&P2MP) for all IoT sensing devices from 111-1 to 120-N capable of exchange information between different parking lot owners who do not use the same type of IoT sensors, thus meeting connectivity, reducing latency, and providing convenience for motorists.

(2) Plug-and-play and point-to-multipoint communication (PnP&P2MP) for all IoT sensing devices from 111-1 to 120-N enables IoT manager 200 to guide batches of arriving motorists to the nearest available parking lots in a fashion that achieves maximum throughput and minimal searching time, reducing traffic congestion and time losses in parking searching engines.

(3) Optimal management of the entire parking environment using deep reinforcement neural network that meets the bandwidth and power consumption requirements as well as other network stabilities. The detailed hardware and software structures of IoT gateways 300-1 to 300-J, servers 210 with deep reinforcement neural network of the present invention will be described in details in the above specified copending application.

Now referring to FIG. 2, a schematic diagram of a network of IoT servers 200 equipped with a smart parking module 260 in accordance with an exemplary embodiment of the present invention is illustrated. It will be noted that a network of IoT servers 200 can be connected as a cluster of different IoT servers 210-1 to 210-O connected and serviced by different networks 201-1, 202-2, to 202-O. IoT server 210-2 and IoT server 210-O can be a pre-existing servers which may be different from or the same as IoT server 210-1 of the present invention. For example, IoT servers 210-2 to 210-O are used by different parking lot owners who hire different management companies to set up these IoT servers for them. More particularly, pre-existing IoT server 210-2 is connected to a second network 201-2 and IoT server 210-O is connected to another network 210-O, both via a communication channel 202. IoT servers 210-1 to 210-O are linked to one another via a communication channel 203. IoT server 210-1 of the present invention is also connected to edge/fog/cloud network 201 via communication channel 202. In some embodiments of the present invention, all IoT servers 210-1, 210, and 210-O may be connected together in a master-slave configuration via communication channel 291 and one server (e.g., 210-1) can serve as a network to the other IoT servers 210-2 to 210-O. As alluded above, networks 201-1 to 201-O can be data center, cloud/edge/fog, or network such as nanonetwork, body area network (BAN), personal area network (PAN), local area network (LAN), campus/corporate area network (CAN), metropolitan area network (MAN), wide area network (WAN), and mesh area networks, or any combinations thereof. Communication channels 202 and 203 can be wireless channels such as Bluetooth, 4G, LTE, 5G, Wi-Fi, Zigbee, Z-wave, radio frequency (RF), Near Field Communication (NFC), Ethernet, LoRaWAN, or can be wired connectors such as RS-232, RS-485, USB, or any combinations thereof. IoT server of the present invention 210-1, pre-existing IoT servers 210-2 and 210-O may use each other as a network using different communication protocols such as Message Queue Telemetry Transport (MQTT), Data Distribution Service (DDS), HTTP, TCP/IP, (Advanced Message Queuing Protocol (AMQP), Modbus, BACnet, OPCUA, or any combinations thereof. It is also noted that pre-existing IoT servers 210-2 and 210-O are IoT servers that are connected to their own edge/fog/cloud network 201-2 to 201-O respectively either before or after IoT server 210-1 of the present invention. IoT servers 210-1 to 210-O may be set up by different manufacturers having different physical connections, communication protocols, industrial standards, as well as operating parameters. They can communicate to one another via communication channel 291 as long as networks 201-1 to 201-O can be linked together, i.e., via a common network such as an edge/fog/cloud network. Alternatively, these IoT servers, 210-1 to 210-Q may use one another as an intermediary server to communicate to other IoT servers.

Continuing with FIG. 2, IoT server 210-1 of the present invention includes a microprocessor 211 in communication with a memory 220 via a bus 162. IoT manager 200 also includes a power supply 212, a network interface 213, a Read Only Memory (ROM), Random Access Memory (RAM) 214, a local input/output interface 215, a display 216, a keyboard 217, audio interface 218, and a pointing device driver 219. Power supply 212 provides necessary power supplies to IoT manager 210-1. Local input/output interface 215 enables input and output communication between microprocessor 211 and display 216, keyboard 217, and pointing device driver 219.

Memory 220 includes a basic Input/Output system (BIOS) 221, a data storage 222, a data repository 230 which includes a parking data bank 231 and data of geographic information system (GIS)/Geographic Position Service (GPS) 232 for all IoT devices 111-1 to 120-N within IoT environment 100. More specifically, memory 220 stores Basic input/output system (BIOS) 221 for controlling the internal operations of IoT server 210-1. Memory 220 also stores an operating system (OS) 221 for controlling the operation of IoT server 210-1. Data storage 222 illustrates examples of computer-readable storage media as well as computer-readable instructions, data structures, program modules or other data for storage of virtual nodes and infrastructure of the entire IoT environment 100. Data storage 222 may be allocated to store network data such as those of network of IoT servers 200. In some other embodiments, data storage 222 may store application specific software programs. It will be appreciated that operating system (OS) and Basic input/output system (BIOS) 221 may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components and/or operating system operations via Java application programs. These components are similar to generic computers that need not described in details herein.

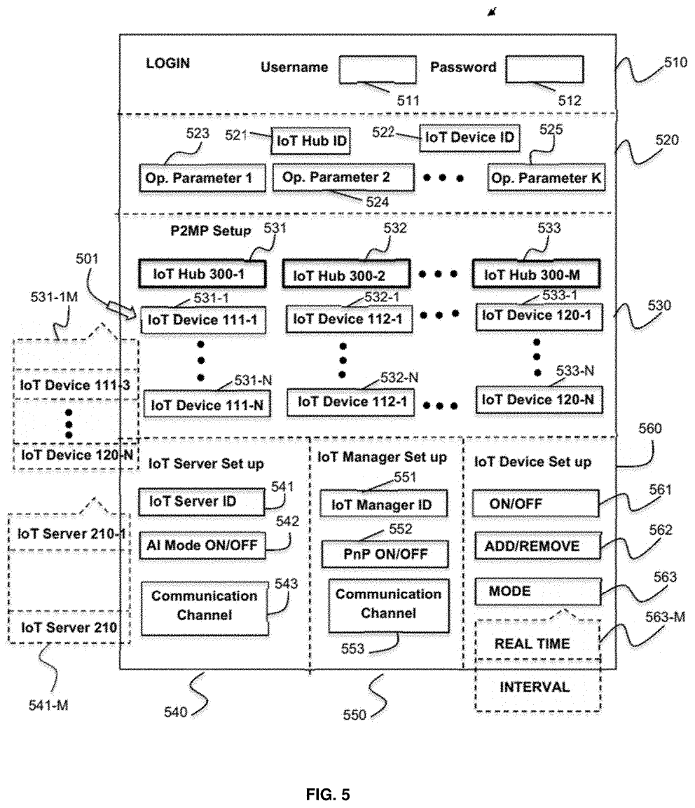

Continuing with FIG. 2, IoT server 210-1 further includes a smart parking application specific module 240 which further includes a webapp configuration module 241 in communication with a gateway manager 242 and an actuator interface 243. Smart parking ASM 240 also includes smart parking module 260 further including a GIS/GPS module 261 and queue forming engine 262. Actuator interface 243 is connected to a switching network/router 244 and gateway manager 245. Gateway manager 242 is operative to (1) obtain and maintain the operating parameters of IoT agents 300-1 to 300-J; (2) implement the control webapp program (see FIG. 5); (3) determine the network topology of system 100 or system 200, i.e., whether they are connected in star, tree, or mesh configuration; (4) simulate the IoT environment; and (5) determine the location of agents 300-1 to 300-J. Actuator interface 243 is a firmware that takes the point to multipoint (P2MP) communication instructions from webapp configuration module 241 and gateway manager 242 and orders switching network 318 to perform this task. Switching network 318 is a hardware device comprised a plurality of transistor switches operative to connect IoT agents 300-1 to 300-J and IoT devices 111-1 to 120-N together in accordance with the instructions from webapp configuration module 241 and actuator interface 243. Webapp configuration module 241 is a software application that receives data information of the infrastructure of IoT environment 100, the virtual nodes representing the P2MP connections between IoT devices 111-1 to 120-N and their respective IoT gateways 300-1 to 300-J to create a graphic user interface (GUI) control webapp program that enables and controls the plug-and-playability and point-to-multipoint communication of the entire IoT environment 100. Webapp configuration module 241 is programmed using Java Script, C++, Python, PHP, Swift-Java, SQL, or HTML 5.

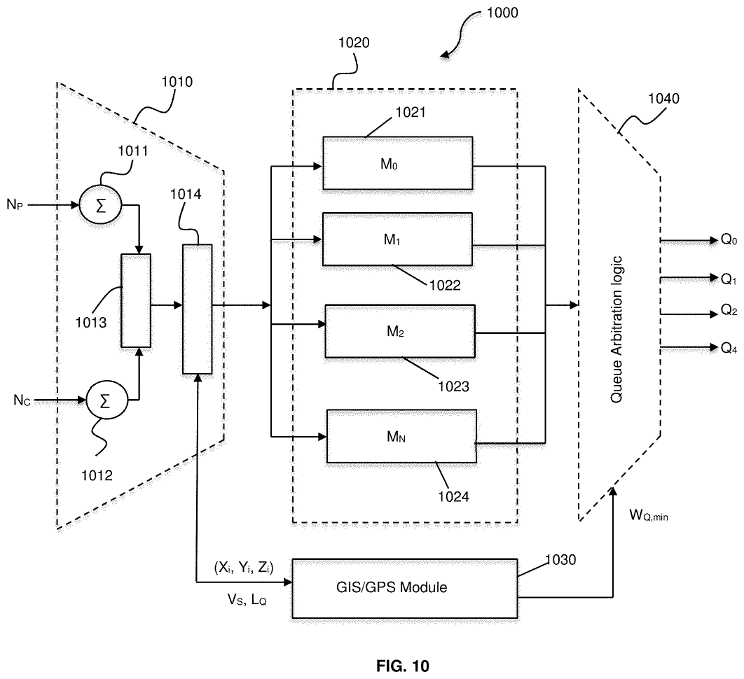

Inside smart parking module 260, queue formation engine 242 is configured to receive multi-layered map data from GIS/GPS module 261 and parking information from IoT devices 111-1 to 120-N to create an adaptive queue model that simulates different real-time parking environments so as to calculate optimal performances. Please refer to FIG. 10 for more details of the adaptive queue model. Once the adaptive queue model is formed, the optimal performances of a parking situation can be realized by means of the PnP&P2MP communication of IoT environment 100 of the present invention. Optimal performances includes maximum throughput, minimum parking searching time, and minimum probability of traffic congestion. GIS/GPS module 261 includes GIS/GPS or Google Map configured to provide coordinate (x, y, z) position of each IoT devices 111-1 to 120-N, motorists, public digital signage, public transportation stations, and stop lights. In many embodiments of the present invention, the GIS map of the wide area where the parking environment is situated is used. Then GPS coordinates metadata are embedded into the GIS map by adding a GPX file into ArcGIS file. This way, all layers of a multistoried parking lots can be displayed. GIS/GSP module 261 is configured to provide geographic data and metadata of a parking environment such as that illustrated in FIG. 7. As described above, gateway manager 242 receives instructions from webapp configuration module 241 to instruct actuator interface 243 to perform plug-and-play and point-to-multipoint (PnP&P2MP) communication for IoT gateways 300-1 to 300-J and IoT devices 111-1 to 120-N. In some embodiments of the present invention, gateway manager 242 is connected to 5G switching network/router 244 to adaptively connect IoT devices 111-1 to 120-N in point-to-multipoint communication fashion. In some embodiments of the present invention, IoT server 210-1 also includes a deep reinforcement neural network (DRNN) 250 configured to predict a set of action map {aₜ} for all IoT devices 111-1 to 120-N, receives observations of transmission rate, bandwidth and power consumption including state changes Sₜ and reward Rₜ. In many aspects of the present invention, DRNN 250 uses map of action {aₜ} to instructs Webapp configuration module 241 to to set up the control webapp to connect IoT devices 111-1 to 120-N according to a policy Pₜ that optimizes the value Q-function, argmaxQ_{(s, a)}.

Continuing with FIG. 2, smart parking module 240 may includes computer executable instructions which, when executed by the control webapp to transmit, receive, and/or otherwise process messages (e.g., SMS, Multimedia Messaging Service (MMS) 271, Instant Message (IM), email, and/or other messages), audio, video, and enable telecommunication with users, at least one motorists mobile devices or display panel on a display panel 272 on the vehicle's dashboard via a communication channel 161. SMS message 251 can be a parking preservation confirmation from any of IoT gateways 300-1 to 300-J which has sent to the handheld smart phone or display panel 252 of a vehicle. In at least one of the various embodiments, smart parking module 260, webapp configuration module 241, queue formation module 262, GIS/GPS module 261, gateway manager 242, actuator interface 243, and DRNN 250 may be implemented as hardware devices such as Google's tensor processing unit (TPU), graphic processing unit (GRU), application specific integrated circuit (ASIC), combinatorial logic circuits, field programmable gate array (FPGA), software applications, and/or the combination thereof. In the artificial intelligent embodiment, when DRNN 250 finds a set of actions {aₜ} that optimizes policy for both bandwidth, transmission rate, and power consumption (argmaxQ_{(s, a)}) the set of action map {aₜ} is mapped into webapp configuration module 241 in order to perform these tasks via actuator interface 243 and switching network 244. Those communication requests that do not meet the policy are queued in data handler 242 and then performed later by gateway manager 242 as the transmission rate, bandwidth and power consumption policy become available.

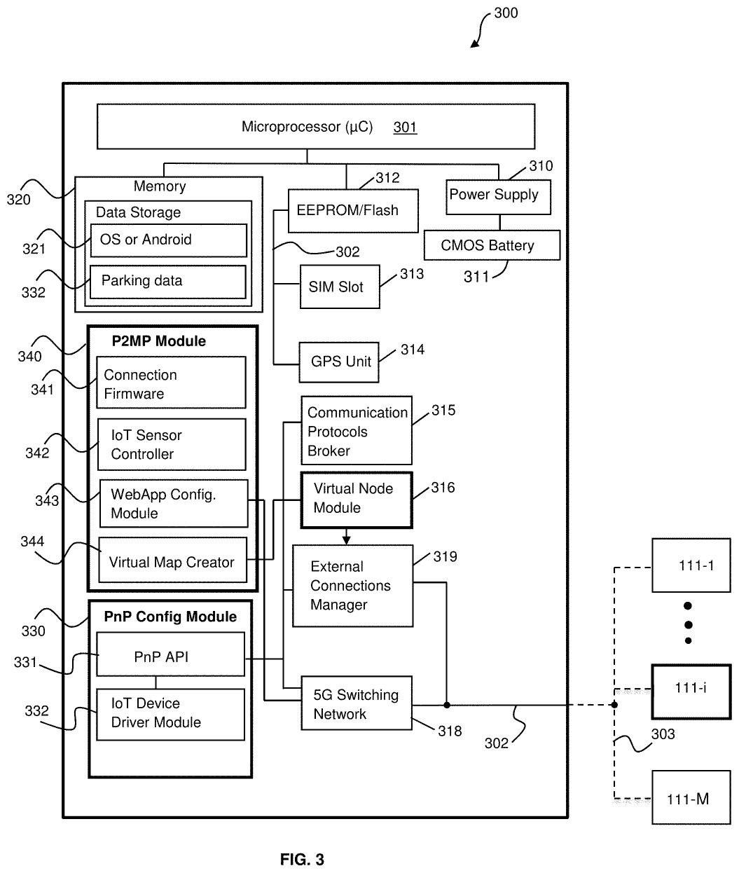

Now referring to FIG. 3, a schematic diagram of an IoT gateway 300 configured to map the virtual nodes and infrastructure of IoT environment 100 in accordance to an exemplary embodiment of the present invention is illustrated. IoT server 210-1 and IoT gateway 300 serve different functions at different levels. At the first level, IoT server 210-1 contains application specific smart parking module 240 that uses webapp configuration module 241 to guide the parking environment of FIG. 7. At a second level, IoT gateway 300 is configured to perform more generic functions such as to set up the PnP&P2MP communication between IoT devices 111-1 to 120-N and 300-1 to 300-J. More particularly, IoT gateway 300 facilitates the parking data collection while IoT server 210-1 uses these parking data collection to perform a specific function application to a specific use. First, IoT gateway 300 is acted as an agent of IoT server 210-1 that carries out the internetwork communication specified by webapp configuration module 343 of IoT server 210-1. For example, IoT server 210-1 may specify IoT gateway 300 to connect IoT devices 111-1, 111-5, 112-6, 113-7, and 120-10 together. Second, IoT gateway 300 is configured to establish plug-and-play and point to multipoint (PnP&P2MP) communication between IoT devices 111-1 to 120-N. That is, gateway 300 also includes modules and utilities configured to retrieve information regarding physical connections, industrial standards, manufacturers, communication protocols, virtual nodes, and infrastructure of the entire IoT environment 100 including IoT servers 210-1 to 210-O.

Continuing with FIG. 3, IoT gateway 300 also includes a power supply 310, a Complementary Metal Oxide Semiconductor (CMOS) supply 310, an Electrically Erasable Programming Memory (EEPROM)/Flash memory 312, a SIM slot 313, a Geo Positioning Satellite (GPS) unit 314, an external connection manager 315, a virtual node manager 316, a communication protocol port 316, a virtual node module 317, and a 5G switching network/router 318. Power supply 310 provides necessary power supplies to IoT gateway 300. CMOS battery 311 is designed to provide voltage supply to IoT gateway 300 when power supply 310 fails. GPS unit 314 stores GPS coordinates metadata for each IoT device 111-1 to 120-N, IoT gateways 300-1 to 300-J, motorists, public transportation stations, public lights, public digital signage, and the entire area, etc. External connections manager 315 detects and manages new connections of new IoT devices 111-1 to 120-N as soon as they have established connection with their relative IoT gateways 300-1 to 300-J. Virtual node module 317 is actually a virtual map of the present P2MP communication among IoT devices 111-1 to 120-N wherein each IoT device is represented by a virtual node which functions as a buffer memory. Communication protocol module 316 detects protocols of IoT devices 111-1 to 120-N as well as other IoT gateways 300-1 to 300-J, motorists, public transportation stations, public lights, public digital signage, etc. In various embodiments of the present invention, external connection manger 315 is a load detector configured to measure the output load and to determine whether new IoT devices are connected therein.

Continuing with FIG. 3, IoT gateway 300 also includes a memory 320, a plug-and-play module 330, and a point to multipoint mapping module (PnP&P2MP) 340. Memory 320 includes an operating system (OS) 321, communication data 322. OS 321 controls the operations of IoT gateway 300. It will be appreciated that operating system (OS) 321 may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components and/or operating system operations via Java application programs. Communication data 332 stores all communication data between IoT devices 111-1 to 120-N, IoT gateways 300-1 to 300-J, and IoT servers 210-1 to 210-O. Plug-and-play (PnP) configuration module 330 includes a plug-and-play (PnP) application program interface (PnP&API) 331 for retrieving operating parameters and industrial standards of IoT devices 111-1 to 120-N. A IoT device driver module 332 supplies device drivers for IoT devices 111-1 to 120-N after PnP API 331 has retrieved respective operating parameters and industrial standards. For example, if any of IoT devices 111-1 or 120-N is a ultrasonic sensor HC0-SR04, PnP API module 331 handshakes with this device to retrieve its operating parameters such as macros: # define HCSR04_ECHO, #define HCSR04_TRIGGER, and #include “hscr04.ceu. Then, IoT device driver module 332 creates the device driver file for this particular sensor such as KMDF driver code using Visual Studio Professional or LINUX™, and modifying the INF file to add operating parameters into the device. PnP configuration module 330 illustrates example of computer-readable storage media as well as computer-readable instructions, data structures, program modules or other data for storage of virtual nodes and infrastructure of the entire IoT gateway 300.

Continuing with FIG. 3, IoT gateway 300 further includes P2MP module 340 which further includes a connection firmware 341, an IoT device controller 342, a webapp configuration module 343, and a virtual map module 316. More particularly, connection firmware 341 is a hardware and software unit designed to code the connections for virtual map module 316 of IoT gateways 300-1 to 300-J and IoT devices 111-1 to 120-N. In some embodiments of the present invention, external connection manager 315 recognizes the plug-and-play communication established between each IoT device 111-1 to 120-N and their respective gateway managers 300-1 to 300-J. Then connection firmware 341 records and codes the connections for virtual node module 316. Virtual map module 316 maps out the current connectivities between IoT devices 111-1 to 120-N and IoT gateways 300-1 to 300-J. This virtual map is similar to that of FIG. 1 where each block, e.g., 111-1 represents a virtual node for storing the exchanged data. Virtual node module 317 manages the communication priorities of these virtual nodes in a predetermined order such as first in, first out (FIFO). In other embodiments, external communication manager 315 is a scanner that scans the RFID, QR, barcodes, other codes that manufacturers printed on each IoT device 111-1 to 120-N. These codes will specify physical connections, communication protocols, types, and manufactures of each IoT devices 111-1 to 120-N and IoT agents 300-1 to 300-J, and IoT servers 210-1 to 210-O. Similarly, in accordance with many embodiments of the present invention, communication protocol module 316 is a hardware and software tool designed to detect the communication protocols of each IoT devices 111-1 to 120-N and IoT agents 300-1 to 300-J, and IoT servers 210-1 to 210-O. As alluded above, different communication protocols includes, but not limited to, Message Queue Telemetry Transport (MQTT), Data Distribution Service (DDS), HTTP, TCP/IP, (Advanced Message Queuing Protocol (AMQP), Modbus, BACnet, OPCUA, or any combinations thereof.

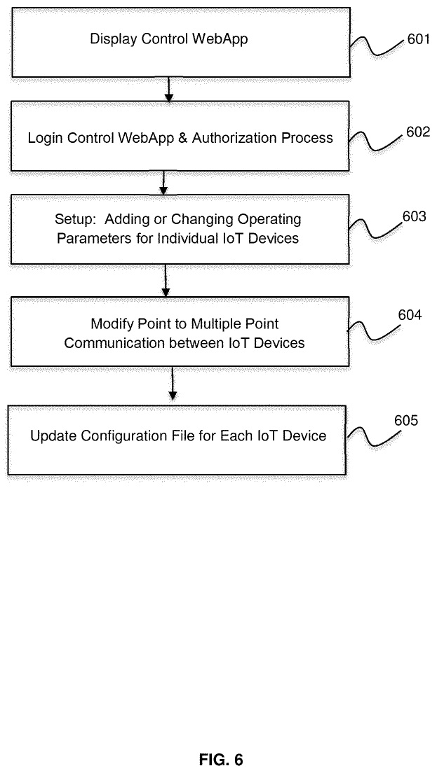

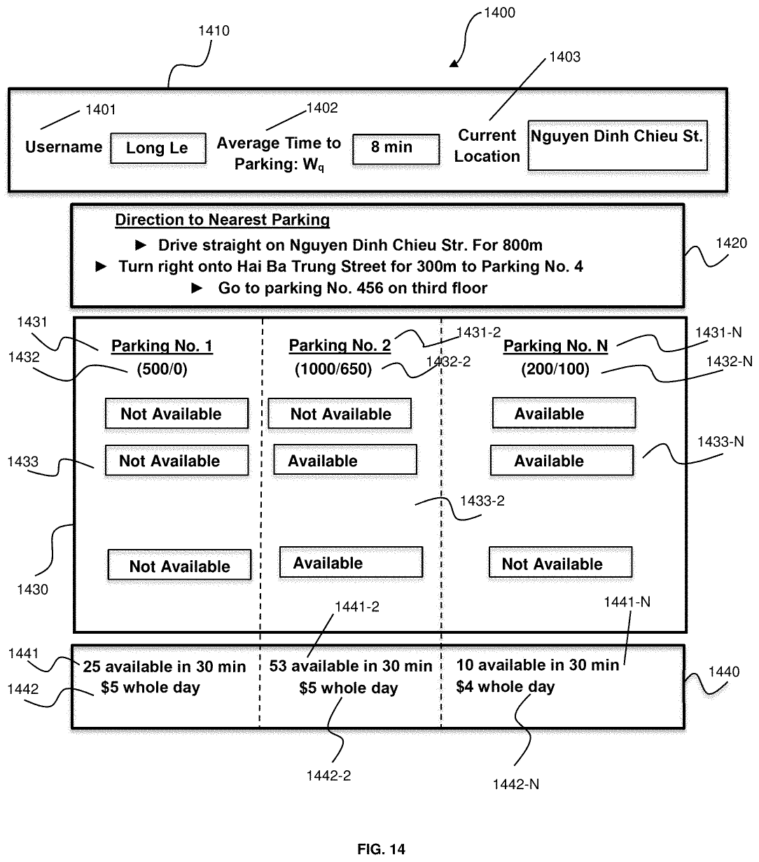

Still referring to FIG. 3, after the physical connections and communication of IoT devices 111-1 to 120-N are determined, PnP module 330 and configuration module 345 send to each integration group 111, 112, 113, and 120 in order to map out the entire virtual nodes and infrastructure of IoT environment 100. Virtual nodes are connection nodes between each IoT gateway 300-1 to 300-J and IoT devices 111-1 to 120-N. From the information about virtual nodes and other information such as physical connections, communication protocols, and manufacturers, configuration module 345 maps out the infrastructure of IoT environment 100 similar to FIG. 1. Virtual nodes and infrastructure will be sent to IoT server 210 so that webapp configuration module 241 creates the control webpage specific to each application. In some embodiments, this webpage application is a generic one similar to that in FIG. 6. Yet in some other embodiments, the webpage application is a smart parking webpage as shown in FIG. 14.

The control webapp application is copied to webapp configuration module 343 in each IoT gateway manager 300-1 to 300-J. This webapp application (please see FIG. 6 and FIG. 14) controls 5G switching network 38 to control the communication channel among IoT devices 111-1 to 120-N. In other words, 5G switching network/router 318 is operable to perform physical point to multipoint communication for I servers 200, IoT gateways 300-1 to 300-J, and IoT devices 111-1 to 120-N. In some examplary embodiments of the present invention, 5G switching network/router 318, IoT device controller 342, and PnP module 330 can be either hardware or software engines or combinations thereof that are situated universally on network 101 or locally on each IoT gateways 300-1 to 300-J. As mentioned before, in case where IoT devices 111-1 to 111-K can be located in different parking areas from IoT devices 112-1 to 112-L and IoT devices 113-1 to 113-M, and 120-1 to 120-N, as shown in FIG. 7. Thus, software devices such as IoT device controller 342, virtual map module 344 of the present invention installed locally on each IoT gateways 300-1 and 300-J or universally on network 101 are necessary to control the communication of IoT servers 200, IoT agents 300-1 to 300-J, and IoT devices 111-1 to 120-N.

The descriptions of FIG. 2 and FIG. 3 achieve the following objectives of the present invention:

(1) Plug-and-play and point to multipoint (PnP&P2MP) communication for any IoT ecosystem can be established; and

(2) The PnP&P2MP communication is controlled by a webapp which is application specific (e.g., generic as shown in FIG. 6 and smart parking as shown in FIG. 14) by virtue of PnP&P2MP module 340, PnP configuration module 330, and optionally smart parking module 240. In specific application, smart parking module 240 is added and then PnP&P2MP module 340, PnP configuration module 330 automatically creates a specific webapp software for smart parking application.

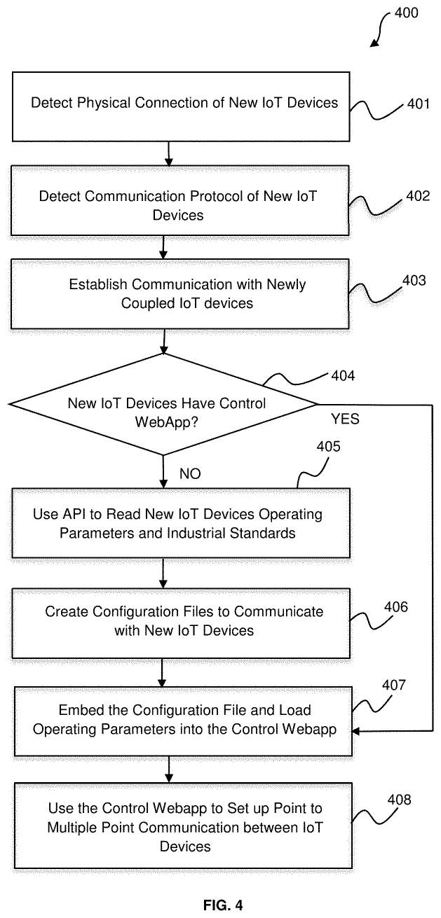

Now referring to FIG. 4, a flowchart 400 illustrating a process of generating and managing a a plug-and-play and point and multipoint (PnP&P2MP) communication for IoT devices 111-1 to 120-N in IoT environment 100 in accordance with an exemplary embodiment of the present invention is illustrated. In various aspects of the present invention, method 400 is implemented to enable any pre-existing IoT servers, any pre-existing IoT agents or hubs or gateways, and any pre-existing IoT devices to become plug-and-play and point to multipoint (PnP&P2MP) communication when connected to network 101 with IoT server 210-1 and IoT gateway 300 of the present invention. In other words, within the scope of the present invention, when IoT gateway 300 and IoT server 210-1 are connected to network 101 with pre-existing IoT gateways 300-2 and 300-N and IoT servers 210-1 and 210-O, IoT gateway 300 and IoT server 210-1 use webapp configuration module 241 to retrieve information regarding physical connections, communication protocols, manufacturers, operating parameters to create virtual nodes and infrastructure of the entire IoT environment 100. Then, connection firmware 341 in IoT gateway 300 loads the information into a template software configuration to create the control webapp using a local webapp configuration module 343. Finally, the control webapp will control and manage the plug-and-play and point to multipoint communication for IoT environment 100. The following steps of method 400 of the present invention disclose the features of the present invention.

At step 401, the physical connections and the existence of IoT devices, IoT agents, IoT servers are detected as soon as the IoT agent and IoT server of the present invention are connected in each of integration groups 111, 112, 113, or 120. In implementing step 401, IoT gateway 300 is used. More particularly, external connection manage 315, communication protocol module 316, connection firmware 341, and PnP API 331 are used. In some embodiments, external connection manager 315 is a scanner that scan barcodes, RFID, QR codes, and any other codes that contain physical connections of each IoT device 111-1 to 120-N. In many embodiments of the present invention, PnP API 331 is sent into IoT environment 100 in order to retrieve the physical connections of newly connected IoT devices 111-1 to 120-N. Physical connections within the scope of the present invention include wireless short range communication channels include ZigBee™/IEEE 802.15.4, Bluetooth™, Z-wave, NFC, Wi-fi/802.11, cellular (e.g., GSM, GPRS, WCDMA, HSPA, and LTE, 5G, etc.), IEEE 802.15.4, IEEE 802.22, ISA100a, wireless USB, and Infrared (IR), LoRa devices, etc. . . . Medium range wireless communication channels in this embodiment of communication link 261 include Wi-fi and Hotspot. Long range wireless communication channels include UHF/VHF radio frequencies. Wired connections include RS-232 and RS-485.

Next is step 402, the communication protocols of each IoT device within the IoT environment is detected. In many aspects of the present invention, step 402 is implemented using communication protocol broker 317. After PnP API 331 has retrieved operating parameters from a particular IoT device, communication protocol broker 317 detects communication protocols used by various IoT devices 111-1 to 120-N. API is a series of codes that make a GET call to the device-id endpoint. Communication protocols usually includes a media section, a channel organization section, and a coordination section. In the media section, bit encoding and transmission are specified. In the channel organization, the types of transmission channels are specified such as duplex or simplex, parallel or serial, and channel. In the coordination section includes clock synchronization, and error detection and correction. Since various IoT devices 111-1 to 120-N may use different communication protocols, communication protocol broker 317 acts as a go-between these IoT devices which are sending and receiving messages. Within the scope of the present invention, communication protocols include Message Queue Telemetry Transport (MQTT), Data Distribution Service (DDS), Web/HTTP-HTML, TCP/IP-Internet, e-mail/IP-Internet, Advanced Message Queuing Protocol (AMQP), Modbus, BACnet, OPCUA, Wireless Application Protocol (WAP), Constrained Application Protocol (CoAP), Extensible Messaging and Presence Protocol (XMPP), or any combinations thereof. Once communication protocols are detected, the sets of hardware/software rules that enables end-points communication between IoT servers 200, IoT agents 300-1 to 300-J, and IoT devices 111-1 to 120-N are known.

At step 403, once physical connections and communication protocols are detected, communication within the IoT environment is established. In various implementations of step 403, IoT device controller 342 and virtual map module 316 map out virtual nodes and the entire infrastructure of IoT environment 100. Virtual node module 317 will receives and stores any messages in accordance to the communication protocols of each IoT device 111-1 to 120-N. 5G switching network/routers 318 implemented as hardware and/or software play important roles in the realization of step 403.

At step 404, whether each IoT device, IoT gateway, and IoT server represented by a virtual node and infrastructure are incorporated into the control webapp is determined. That is, whether the operating parameters of each IoT device 111-1 to 120-N, IoT gateways 300-1 to 300-N, and IoT servers 210-1 to 210-O are included in the webapp control page is determined. Step 404 is implemented by IoT device controller 342 and virtual map module 316. In many aspects of the present invention, IoT device controller 342 and virtual map module 316 go into webapp configuration module 343 to check if newly found virtual nodes and infrastructure have been embedded in the control webapp in form of software buttons and device engines designed to control the plug-and-play and point to multipoint communication for each virtual node and each infrastructure.

At step 405, if the answer to step 404 is NO, operating parameters, industrial standards, physical connections, communication protocols of each IoT device, IoT agent, IoT server are read and embedded into each virtual node and the webapp control is populated. Consequently, each virtual node representing an IoT device is provided with an device ID. In many aspects of the present invention, step 405 is implemented by PnP API 331 including many device engines that enter each IoT device 111-1 to 120-N, each IoT gateways 300-1 to 300-J, and IoT servers 210-1 to 210-O to retrieve these information. In some other aspects of the present invention, external connection manager 315 can be used to scan in the barcodes, QR codes, optical codes, RFID codes, and other codes that contain the above information.

Next, at step 406, the above information is incorporated into a configuration file. In some aspects of the present invention, configuration file is created and maintained by webapp configuration module 343 in form of a software template. Information regarding physical connections, communication protocols, operating parameters, manufacturers, virtual nodes, and infrastructure are filled in entries of the software template. Please refer next to FIG. 6 for an non-limiting example of the webapp control template.

At step 407, virtual map of communication between IoT devices and IoT gateways are into the configuration module to established P2MP communication in the Internet of Things environment. Step 407 is realized by action connections firmware 341 configured to take information virtual map module 316 to connect webapp configuration module 343. Webapp configuration module 343 uses the configuration file to create a specific control webapp applicable to each application as shown in FIG. 6. The control webapp is an active software program that contains many device engines, plug and play API that are controlled by device controller module 342 and IoT device gateway 342.

At step 408, plug-and-play and point to multipoint communication (PnP&P2MP) of the IoT environment is controlled by the control webpage. In many aspects of the present invention, when a user registers to use the services provided by the control webapp, the user first logs in and sets the operations of IoT environment 100. Once the plug-and-play and point to multipoint communication (PnP&P2MP) is set, the control webapp sends out instructions to virtual node manager 316, external connection manager 315, and IoT device controller 342 to perform the tasks set by the user. Referring back to step 408, when a newly connected IoT is connected to a pre-existing IoT environment and it is determined that this newly connected IoT device is already incorporated in the control webapp, step 408 is performed.

In summary the following objects of the present invention are achieved by process 400 of the present invention:

Point to multipoint (P2MP) communication in the Internet of Things environment shown in FIG. 1 is automatically established and performed in the direction that meets bandwidth and power consumption constraints without substantial latency and network instability.

An IoT environment that can achieve plug-and-play and point to multipoint communication for all IoT devices, IoT agents regardless of their industrial standards, physical connections, and communication protocols.

After connected to any pre-existing IoT environment, the IoT agent and IoT server of the present invention are capable of rendering such pre-existing IoT environment into a plug-and-play and point-to-multipoint communication IoT environment.

A plug-and-play and point-to-multipoint platform that can provide real-time data for all IoT devices connected thereto to increase the data analytics capability and artificial intelligence/machine learning to accurately predict the behaviors of users.

### Example of Plug-and-Play and Point to Multiple Point (PnP&P2MP) Communication of Method 400

Referring back to FIG. 3 and FIG. 4, assume IoT device 111-i is an ultrasonic distance detector modeled number HC-SR04. First integration group 111 is a parking garage that uses this distance detector in each parking space. IoT device 111-i is placed either overhead or underground of a parking space. IoT device 111-i determines the availability of a parking space. Parking garage 111 uses IoT gateway 300-1 to facilitate the communication of all IoT devices or distance detectors 111-1 to 111-K. As soon as IoT device 111-i is connected to IoT gateway 300-1, external connection manager 315 detects the presence of the motion detector by (1) load detector or (2) communication API from IoT 111-i to IoT gateway 300-1. External connection manager 315 informs communication protocols broker 316 about the newly connected device (IoT device 111-i which is an ultrasonic motion detector HC-SR04). In turn, communication protocols broker 316 detects or acknowledges the communication protocol current in use, i.e., TCP/IP-Internet or LoRaWAN. Then PnP API 331 is sent out to retrieve operating parameters of HC-SR04 regarding its microcontroller (MCU) such as Ardunio Uno, DSP, AVR, PIC, ARM. These information is fed to IoT device driver module 332 to determine whether HC-SR04 device driver is already available. If the device driver does not exist, then driver compilation file creates the HC-SR04 device driver using command line directed at the driver file location with the following commands: 1. Make; 2. Insmod hc_driver.ko. Virtual map module 316 adds a virtual node representing this IoT device 111-i to the existing virtual map. Virtual node module 317 is a kind of priority and interrupt for each IoT device. Finally, the operating parameters of HC-SR04 is added to the control webapp so that PnP&P2MP communication between this device to other IoT devices 111-1 to 120-N is possible.

Referring now to FIG. 5, a perspective view of a control webapp 500 configured to set up and manage the plug-and-play and point to multipoint communication between IoT gateways 300-1 to 300-J, servers 200, and IoT devices 111-1 to 120-N in accordance with an exemplary embodiment of the present invention is illustrated. In many embodiments of the present invention, control webapp 500 is created by webapp configuration module 343 which receives virtual nodes, infrastructure, physical connections, communication protocols, industrial standards, and operating parameters information from connection firmware 341, communication protocol broker 316, and PnP API module 331.

In one particular embodiment of the present invention, control webapp 500 is displayed as a webapp on a computer screen of a user with a pointing device 501. In other embodiments of the present invention, control webapp 500 can be displayed on a touchscreen of a mobile phone and pointing device 501 is a finger of a user.

Continuing with FIG. 5, in an exemplary embodiments of the present invention, control webapp 500 includes a login section 510, a IoT device reading section 520, a point to multipoint setup section 530, an IoT server setup section 540, a IoT agent setup section 550, and an IoT device setup section 560. Login section 510 further includes a username window (or box) 511 and a password window (box) 512 for a user to perform a two step authentication process. Other methods of authentication such as scanning in barcodes, QR codes, RFID, or sending an authentication code to a registered email are also within the scope of the present invention.

IoT device reading section 520 includes an IoT agent box 521, IoT device 522. Below are all current operating parameter boxes such as operating parameter 1 523, operating parameter 2 524, and operating parameter K 525. A non-limiting example of IoT device reading section 520 is the display of the IoT device 522 as an ultrasonic distance detector HC-SR04 with first operating parameter 1 523 being distance (2 cm to 450 cm), and operating parameter 2 524 being maximum angle (15 degrees). For example, the user can set the maximum angle of detection. Operating parameter K 525 is the degree of precision (3 mm). IoT agent box 521 is the hub or gateway where the AC is directly connected to. It is noted that the user can add or remove the operating parameters 523-525. For example, the user can add in the angle and/or the direction of the fan of the AC as other operating parameters. The connection between each IoT device 111-1 to 120-N and its IoT agents 300-1 to 300-J forms a virtual node which includes all the operating parameters 523 to 525. Behind IoT box 521 and IoT device ID box 522 are PnP API 331, webapp configuration module 343 and and their corresponding device engines that enter each IoT device 111-1 to 120-N to retrieve the necessary information such as operating parameters, communication protocols, physical connections, etc. so that webapp configuration module 241 can build control webapp 500 and IoT device reading section 520.

Continuing with FIG. 5, P2MP setup section 530 includes a matrix of IoT agents and IoT devices. Particularly, in the first column, IoT agent 300-1 box 531 includes all IoT device 111-1 box 531-1 to IoT device 111-N box 531-N that are connected directly to IoT agent 300-1. Similarly, in the second column, IoT agent 300-2 box 532 includes IoT device 112-1 box 532-1 to IoT device 112-N box 532-N. In the last column, IoT agent 300-J box 533 includes IoT device 120-1 box 533-1 to IoT device 112-N box 532-N. Referring again to FIG. 1, this map is achieved by virtues of PnP API 331 webapp configuration module 343 and and their corresponding device engines. In one exemplary embodiment of the present invention, when a user sets up the point to multipoint communication between these IoT devices 111-1 to 120-N, the user can move pointing device 501 to any of the above listed boxes, a dropdown menu 531-M will appear. The user only needs to click on any IoT devices, namely, 111-2 to 120-N in order to connect them to IoT device 111-1.

Still referring to FIG. 5, in IoT server setup section 540, an IoT server ID box 541 lists all IoT servers 120-1, 120-2, and 120 that are currently active. When the user moves pointing device 501 to IoT serve ID box 541, a dropdown menu 541-M informs the user all IoT servers that are active and detected by PnP API 331 and webapp configuration module 343 and and their corresponding device engines. Next, an artificial intelligence/machine learning box 541 can be turned on or off. When box 541 is turned on, AI/ML module 245 will perform data analytics and automatically set up point to multipoint communication for the user. The results will be displayed in P2MP setup section 530. A communication channel box 543 displays the physical connections and communication protocols of the currently displayed IoT server in box 541. It will be noted that other information such as manufacturers, IoT server ID can also be displayed in box 540.

Continuing with FIG. 5, in IoT agent setup section 550, an IoT agent ID box 551 lists all IoT agent 300-1 to 300-J that are currently active. When the user moves pointing device 501 to IoT agent ID box 551, a dropdown menu (not shown) informs the user all IoT agents that are active and detected by PnP API 331, webapp configuration module 343 and and their corresponding device engines. Next, a plug-and-play box 551 can be turned on or off. When box 552 is turned on, PnP API 331 causes all IoT devices 111-1 to 120-N to be in plug-and-play mode. A communication channel box 553 displays the physical connections and communication protocols of the currently displayed IoT agent in box 551. It will be noted that other information such as manufacturers, IoT agent ID can also be displayed in box 550.

In IoT device setup section 560, an ON/OFF box 561 allows the user to turn on or off the modification for each IoT device 111-1 to 120-N. If box 561 is turned on, it allows the user to either add or remove operating parameters in an add/remove box 562. If the user changes operating parameters of an IoT device, IoT device reading section 520 will change accordingly. Finally, a mode box 563 sets either real-time mode or interval mode for each IoT device 111-1 to 120-N. When the user moves pointing device to mode box 563, a dropdown menu 563-M listing all the modes of each IoT device will appear to allow the user to select the mode of data transmission. As a non-limiting example, when the user wants IoT device 120-1 to transmit data in the real-time mode, the user shall do to the IoT device reading section 520 to change IoT device ID box 522 to display IoT device 120-1 and IoT agent ID box 521 to IoT manger 300-J. Then the user moves pointing device 501 to mode box 563 to select the real-time mode. As a result, IoT device 120-1 starts to send data to be displayed in IoT device reading section 520 in real-time manner.

Referring to FIG. 6, a flow chart illustrating a method 600 of setting up and managing a point to multipoint communication between IoT devices, IoT agents, and IoT servers within an IoT environment using a control webapp in accordance with an exemplary embodiment of the present invention is illustrated.

At step 601, a control webapp is activated and displayed. In accordance with many embodiments of the present invention, the control webapp is an interactive tool that directly controls the plug-and-play and point to multipoint communication between IoT devices 111-1 to 120-N in a manner described above in FIG. 2 to FIG. 3. Step 601 is implemented by control webapp 500. The detailed description of control webapp 500 is described above in FIG. 5.

At step 602, a subscribed user signs in and carries out the authorization process. Step 602 is implemented by log-in section 510.

At step 603, operating parameters for each IoT device are modified. Step 603 is implemented by IoT device reading section 520 and IoT device setup section 560.

At step 604, whether operating parameters of IoT devices, IoT agents, and/or IoT servers are modified by users. If the answer is YES, then at step 605, the DRNN algorithm 250 is performed. That is, a new action map {aᵢ} is proposed, reward function Rt, argmaxQ(s, a) are recalculated to determine whether the bandwidth and power consumption are met.

At step 606, configuration file is updated. The configuration file is updated based on the changes that user selects in step 602 to 604. Step 605 is implemented by webapp configuration module 241, DRNN 250, webapp configuration module 343, IoT sensor controller module 342, and PnP API 331.

At step 607 and step 608, if there are no change in the operating parameters then P2MP communication among IoT devices continues.

As disclosed in FIG. 1 to FIG. 6, the following objectives of the present invention are achieved:

An IoT environment that can achieve plug-and-play and point to multipoint (PnP&P2MP) communication for all IoT devices, IoT agents regardless of their industrial standards, physical connections, and communication protocols.

After connected to any pre-existing IoT environment, the IoT agent and IoT server of the present invention are capable of rendering such pre-existing IoT environment into a plug-and-play and point-to-multipoint communication IoT environment.

A plug-and-play and point-to-multipoint (PnP&P2MP) platform that can provide real-time data for all IoT devices connected thereto to increase the data analytics capability and artificial intelligence/machine learning to accurately predict the behaviors of users.

Next, FIG. 7-FIG. 14 illustrate a smart parking that is based on the PnP&P2MP IoT environment as described above. The smart parking is an application of the PnP&P2MP communication of the present invention. As will be seen, because of PnP&P2MP communication of the present invention, information from different IoT devices from different manufacturers and different parking owners can be collected that facilitate the analytics leading to the solution of the parking problems: (1) minimum searching time and (2) maximum throughput without traffic congestions.

Now referring now to FIG. 7, a 3D perspective diagram of a parking environment 700 is illustrated. In many aspects of the present invention, parking environment 700 includes a main street 701 with a first cross street 702 and a second cross street 703, assuming all streets two-way traffics. A first traffic flow 751 is into the page on main street 701. A second traffic flow 752 is opposite to first traffic flow 751, emerging out of the page. On first exit street 702, a third traffic flow 753 is to the right of first traffic flow 751 while a fourth traffic flow 754 is opposite to third traffic flow 753 and emerging to main street 701. On second cross street 703, a fifth traffic flow 755 is on the left of first traffic flow 751. A sixth traffic flow 756 is emerging to the left of first traffic flow 751 and opposite to first traffic flow 755. All traffic flows 751-756 include a plurality of vehicles most of whom are seeking for parking spaces.

Continuing with FIG. 7, in a non-limiting illustration, parking environment 700 includes a first parking area 710 which is shopping complex. First parking area 710 can be represented by first integration group 111 in FIG. 1. Similarly, a second parking area 720 is a villa complex represented by second integration group 112. A third parking area 730, a high-rise condo complex, is represented by third integration group 113. And a fourth parking area 740, an empty lot, represented by fourth integration group 120. First parking area 710 includes a multi-storied parking structure 711 with parking spaces 711¹_11 to 711^{N}_KL, where L is the number of rows, K is the number columns and N is the number of levels. First parking area 710 also includes a first shopping building 712 having a first outdoor parking structure 712-1. A second shopping building 713 has an second outdoor parking structure 713-1. A third shopping building 714 has a third outdoor parking structure 714-1. A fourth shopping building 715 has a fourth outdoor parking structure 715-1. Inside first shopping building 712 to fourth shopping building 715 all include a movie theater complex, restaurants, shopping stores, and dining courts. In some embodiments of the present invention, multi-storied parking structure 711 to fourth outdoor parking structure 715-1 can be part of first integration group 111 and each is equipped with respective IoT device 111-1 to 111-K, IoT gateway 300-1, and IoT server 210-1. In other embodiments of the present invention, first parking structure 711 can be represented by the entire system 100 in which multi-storied parking structure 711 is first integration group 111 with its own IoT gateway 300-1; first outdoor parking structure is second integration group with IoT gateway 300-2; second outdoor parking structure 712 is represented by third integration group with IoT gateway 300-3; third outdoor parking structure 713 is represented by fourth integration group 114 (not shown) with IoT gateway 300-4; and a fourth outdoor parking structure 714 is represented by integration group 120 with IoT gateway 300-J. First parking area 710 is serviced by network 101.

Continuing with FIG. 7, second parking area 720 is a villa complex that includes a plurality of mansions with a public parking structure 721 for guests. In some embodiments of the present invention, public parking structure 721 is represented by second integration group 112 with IoT devices 112-1 to 112-L, IoT gateways 300-2, and IoT server 210-2. Third parking area 730 is a high-rise condominium that include high-rises condos 731 with a first level and a second level underground parking structures 732-1 and 732-2. A ground level parking structure 733 which is an open parking structure for guests and for the public. In some embodiments of the present invention, these parking structures 732-1, 732-2, and 733 are represented by third integration group 113. Underground parking structures 732-1, 732-2, and 733 are equipped with IoT devices 113-1 to 113-M, IoT gateway 300-3, and IoT server 210-3. Fourth parking area 740 is an empty lot with an open parking structure 741, which is represented by fourth integration group 120 with IoT devices 120-1 to 120-N, IoT gateway 300-4, and IoT server 210-O, with J and O equal to 4. It is noted that parking environment 700 can be extended to a smart city, airport, university campus, etc. Each individual parking space for a vehicle listed above is equipped with a smart parking unit 800 of the present invention.

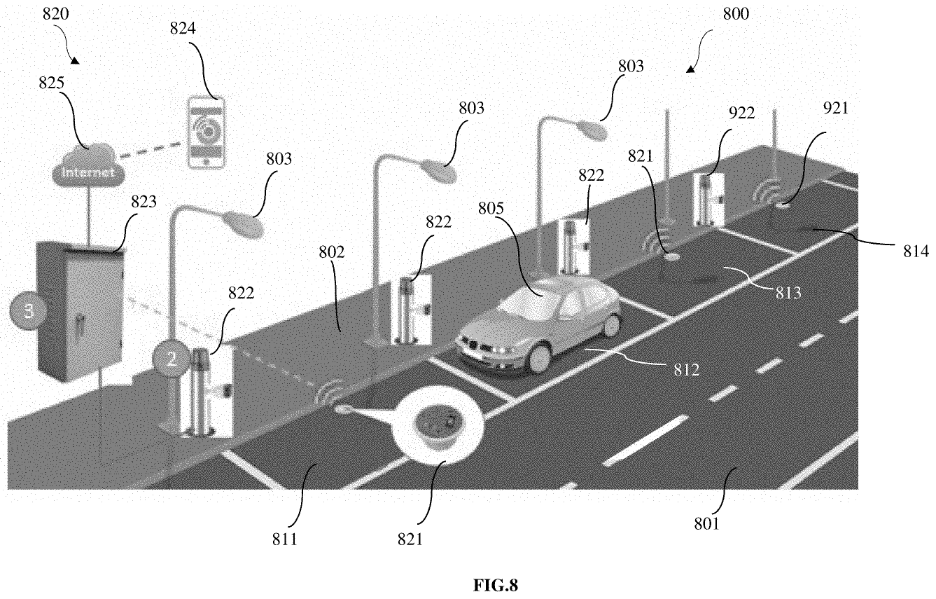

Next, referring to FIG. 8, a 3D perspective view of a segment of a parking lot 800 of parking environment 700 described in FIG. 7 in accordance with an exemplary embodiment of the present invention is illustrated. Representative parking section 800 is equipped with a smart parking equipment 820 of the present invention. In actuality, smart parking equipment 820 includes an IoT device 821, a status pole 822, a parking gateway 823, a parking webapp 824, and a network 825. IoT device 821 is a parking detector of the type of ultrasonic distance detector HC-SR04, one type of IoT device 111-1 to 120-N. IoT gateway 823 is IoT gateway 300-1. In some embodiments of the present invention, IoT gateway 823 (IoT gateway 300-1) uses LoRA gateway. Network 825 is represented by network 101 as described in FIG. 1. Parking control webapp 824 is webapp control 500 as depicted in FIG. 5, configured to apply to smart parking of the present application. Please see FIG. 14. Status pole 822 includes a confirmation scanner (not shown), a camera (not shown), a status light (not shown), and an automatic payment receptor configured to accept credit card, cash, and other types of electronic payments. The details of status pole 822 will be described later.

Continuing with FIG. 8, parking section 800 includes individual parking spaces 811-814, a main driveway 801, a sidewalk 802, and light poles 803. In each parking space 811-814, IoT parking sensor 821 is deployed to sense whether a car 805 is parked in there or not. In other words, IoT parking sensor 821 determines the availability of individual parking space 811-814. In various embodiment of the present invention, parking segment 800 is repeated and multiplied throughout parking environment 700 described above so that a smart parking system similar to PnP & P2MP system in FIG. 1 to FIG. 6 is achieved. Each individual parking space in parking structures 711-715, 721, 732-1, 732-2, 733, and 741 in FIG. 7 includes parking sensors 821, status pole 822, and a motorist 805 with webapp control program 824. Parking section 800 of parking structure 711-715, 721, 732-1, 732-2, 733, and 741 includes IoT gateway 823. The entire parking environment 700 is connected to one or more networks 825 (or network 101 in FIG. 1). As described in FIG. 1 to FIG. 6, each IoT device 821 in a parking structure (e.g., 711-715, 721, 732-1, 732-2, 733, and 741 in FIG. 7) can communicate to the IoT parking devices in other parking structures so that traffic congestions and searching time losses can be minimized.

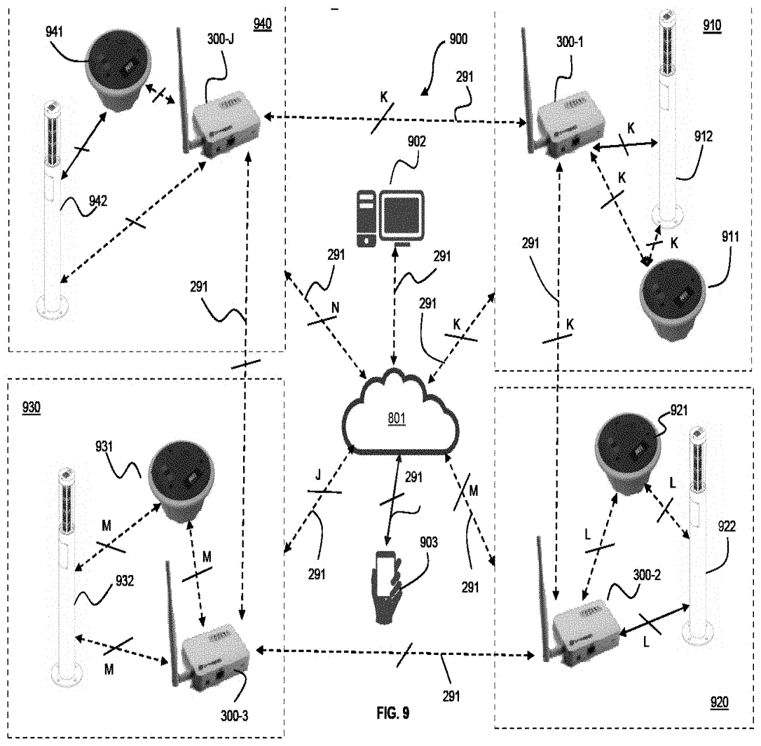

Next referring to FIG. 9, an interconnectivity schematic diagram 900 of a smart parking environment capable of plug-and-play and point to multipoint (PnP & P2MP) communication to one anther configured to reduce time losses and traffic jams in accordance with an exemplary embodiment of the present invention is illustrated. A first parking arrangement 910 presents parking structures 711-715 in first parking area 710. A second parking arrangement 920 presents parking structure 721 in second parking area 720. A third parking arrangement 930 represents parking structures 731-1, 732-1, 732-2, and 733 in third parking area 730. A fourth parking arrangement 940 represents parking structure 741 in fourth area 740. In first parking arrangement 910, a plurality of IoT devices 911 in communication with a plurality of status columns 912 and IoT parking gateway 300-1. Parking arrangement 910 is the realization of first integration group 111 in which plurality of sensors 911 is IoT devices 111-1 to 111-K. Similarly, second parking arrangement 920 is the realization of second integration group 112 in which plurality of sensors 922 represents IoT devices 112-1 to 112-L. Third parking arrangement 930 is the realization of third integration group 113 in which plurality of sensors 932 represents IoT devices 113-1 to 113-M. Fourth parking arrangement 940 is the realization of integration group 120 in which plurality of IoT sensors 942 represents IoT devices 120-1 to 120N. Parking arrangements 910 to 940 are communicating with one another and to a network 901 via wireless communication channels 291. Network 901 is represented by edge/fog/cloud server 101. A parking central server 902—which is an embodiment of IoT server 200—communicates to parking arrangements 910-940 also via wireless communication channels 291 and server 901. A plurality of users/motorists who use smart phones 903 can view, select, book, access to each of parking structures 711-715, 721, 731, 732-1, 732-2, 733, and 741 by the virtue of smart parking system 900 using PnP and P2MP IoT platform of the present invention.

Referring now to FIG. 10, a schematic diagram of a queue formulation engine 1000 responsible for modeling any parking situation in order to achieve maximum throughput, minimum parking searching time, and minimum traffic congestion in accordance with an exemplary embodiment of the present invention is illustrated. Queue formulation engine 1000 is a part of smart parking module 240. After all parking information are collected by IoT gateways 300-1 to 300-J from IoT sensors 942 from parking environments 910-940 as specified in FIG. 7 and FIG. 9, queue formation engine 1000 uses these information to model a queueing system for parking situation at time t. Let N_{P} be the number of available parking spaces at time t from all parking 910-940. Let N_{C} be the number of motorists who are seeking for a parking spaces in parking environment 700 described above in FIG. 7 and FIG. 9.

Continuing with FIG. 10, queue formulation engine 1000 is designed to formulate a queuing model for a particular parking situation in order to (1) calculate the maximum throughput and (2) basis for guiding motorists to the nearest available parking that will avoid traffic congestion and time losses. Queue formulation engine 1000 includes an Arithmetic logic unit (ALU) 1010, a memory bank 1020, a GIS/GPS module 1030, and a queue arbitration logic 1040. ALU 1010 further includes a first adder 1011, a second adder 1012, a comparator 1013, and a logic unit 1014. Memory bank 1020 further comprises a first memory storage M₀ 1021, a second memory storage M₁ 1022, a third memory storage M₂ 1023, and an N^{th} memory storage M_{N} 1024 for storing incoming traffic, e.g., 951-956 in queue waiting for available parking spaces. First adder 1011 receives the total number of available parking spaces (N_{P}). Each parking space also receives its coordinates (x, y, z) from GIS/GPS module 1030. First adder 1011 adds up the total number of available parking spaces N_{P} from all parking areas 710-740. Second adder 1012 receives the total number of motorists N_{C} who are looking for a parking space. Each motorist has a coordinates (x, y, z) and a velocity V_{S}. Second adder 1012 adds up the total number of parking requests N_{C}. Comparator 1013 compares these two numbers N_{P} and N_{C}. In situation where N_{P} is substantially larger than N_{C}. That is, the total number of parking available N_{P} is substantially greater than that of the total parking demands by the motorists N_{C}, N_{P}>>N_{C}. Then, motorists may drive to a nearest parking structure. Alternatively, motorists may drive under the instructions of queue formation engine 1000. On the other hands, when the demands for available parking spaces are substantially greater than the total number of available parking spaces (N_{C}>>N_{P}), then controller 1014 calculates the time of arrival (TOA) to the nearest available parking spaces for each motorist. This TOA is called minimum waiting time in queue or minimum waiting time (W_{Q,min}). It is noted that the minimum waiting time in queue for each motorist (W_{Q,min}) is not the same as time to the nearest parking area (i.e., 710-740) since the nearest parking area to a motorist may not have any available parking spaces. The minimum waiting time in queue (W_{Q,min}) for each motorist searching for available parking spaces equals to the distance L_{Q} to the nearest parking space divided to the velocity (V_{S}) of that motorist.

Continuing with FIG. 10, after calculating the minimum time in queue (W_{Q,min}), controller 1014 sorts motorists seeking for available parking spaces according to their coordinate location (x, y, z) for each parking area 710-740. Next, controller 1014 temporarily stores each queue to different memory banks, M₀ to M_{N}, in accordance with minimum waiting time and parking areas 710-740 as servers. Finally, queue arbitration logic 1040 forms a queuing model including a single batch arrival with one to many servers, a multiple batch arrivals with one to many servers, depending on each parking searching situation. In effect, queue arbitration logic 1040 decides on a specific queue model depending on the minimum waiting times (W_{Q,min}) and the coordinate location of each parking area 710-740.

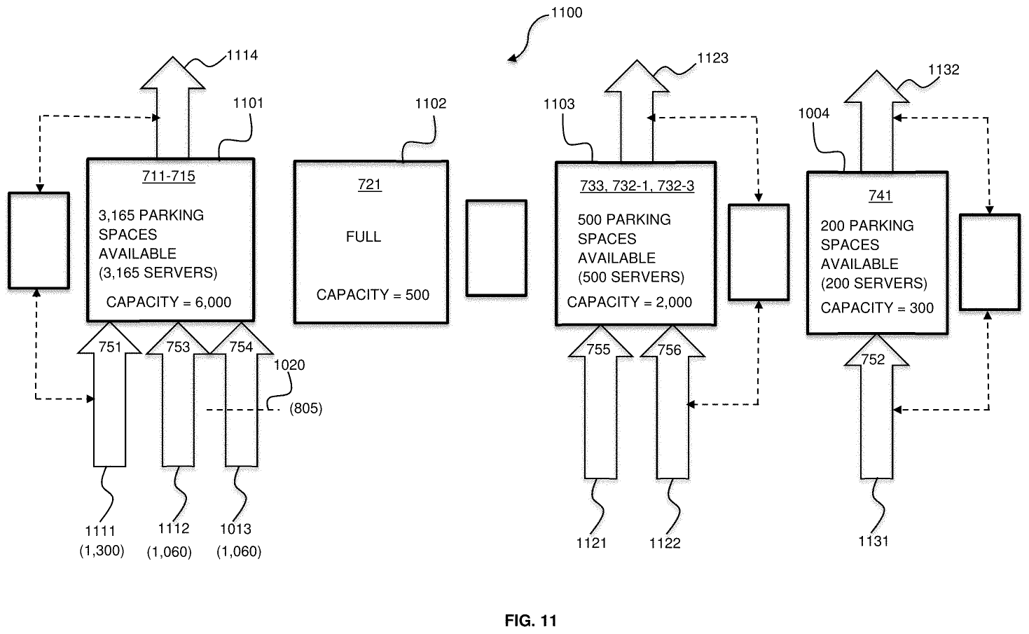

Next referring to FIG. 11, a diagram illustrating a multiserver queuing system 1100 modelled after the parking environment of FIG. 7 by the smart parking system in accordance with an exemplary embodiment of the present invention is illustrated. Referring back to FIG. 7, assume that the number of motorists seeking for available parking spaces is substantially less than that of the number of available parking spaces (N_{P}<<N_{C}). Assume further that parking arrangement 721 is full, no available parking spaces. This information is possible because of the PnP&P2MP communication system as described in FIG. 1 to FIG. 6, and FIG. 9. Assume that parking area 710 has a capacity of 6,000 parking spaces, parking area 720 has 500 parking spaces, parking area 730 has 2,000 parking spaces, and parking area 740 has 300 parking spaces. At time t, there are only 3,165 parking spaces still available (empty), and 2,935 parking spaces are occupied in parking area 710. Parking area 720 is full, no more available parking spaces. In parking area 730, there are 500 available parking spaces, 1,500 parking spaces are taken. In parking area 740, there are 200 parking spaces still available and 100 are taken.

Continuing with FIG. 11 and referring back to FIG. 7, queue formation engine 1000 as described above forms three different parking queue models: A first queue model 1101 is a multiple queues in a multiple servers for parking area 710. First traffic flow 751 is presented by a queue 1111 with 1,300 motorist looking for available parking spaces. Second traffic flow 753 is represented by a queue 1112 with 1,060 motorists looking for available parking spaces. Third traffic flow 754 is represented by a queue 1113 has 1,150 motorists looking for available parking. First queue model 1101 is serviced by smart parking module 240 and related IoT gateway 300-1 to 300-J. In first queue model 1101, since the number of motorists searching for available parking spaces is greater than the available parking spaces, smart parking module 240 issues a cutoff line 1020 informing the 346^{th} motorist and beyond in third queue 1013 that parking area 710 is full. A second queue model 1102 is not formed since parking area 720 is full. That is, all traffics are diverted to nearby parking areas, e.g., 710, 730, and 740. Consequently, motorists will not waste time drive into parking area 720 to futilely search for a parking space and then drive out, causing traffic congestion. A third queue model 1103 is also a multiple queue in a multiple servers for parking area 730. A fourth traffic flow 755 is represented by a batch arrival queue 1121 with 200 motorists searching for available parking spaces for parking area 730. A fifth traffic flow 756 is represented by a batch arrival queue 1122 with 300 motorists searching for available parking spaces for parking area 730. Finally, a fourth queue model 1104 is also a single queue in a multiple servers for parking area 740. A sixth traffic flow 752 is presented by a single batch arrival queue 1131 with 200 motorists searching for available parking spaces for parking area 741. It is noted that each parking space equipped with IoT device 111-1 to 120-N is a parking server. Third and fourth queue models 1103 and 1104 are also serviced by smart parking module 240 respectively.

Continuing with FIG. 11, in various embodiments of the present invention, smart parking module 240 also takes into considerations of the amount of motorists who will be leaving their parking spaces within a preset time Δt, rendering these parking spaces available. The present time Δt may be 15 minutes or 30 minutes, depending on the distribution of queues 1111 to 1131. First queue model 1101 has an outflow 1114 within preset time Δt. Similarly, third queue model 1103 has an outflow 1123 and fourth queue model 1004 has an outflow 1132. ALU 1013 of queue formulation engine 1000 of smart parking module 240 adds these parking spaces to the total amount of available parking spaces. As a result, cutoff line 1020 is extended by an amount L which equals to average velocity times Δt. In the example of first queue model 1101, if the number of available parking spaces within preset time Δt is 500. That is 500 motorists will leave this parking area 710 within preset time Δt. Cutoff line 1020 will extend to 845. In practice, queueing model 1100 is built by Python object oriented program (OOP). From the foundation of PnP&P2MP exchanging of parking information and queueing model 1100, analytics such as distribution of incoming motorists, service time, etc. can be calculated in order to eliminate externalities caused by time losses and traffic congestion.

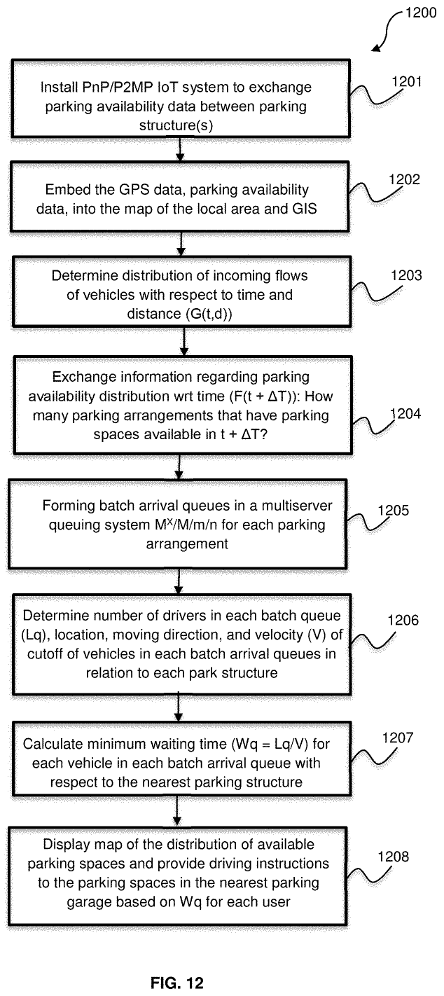

Now referring to FIG. 12, a flow chart of a method 1200 for a wide area smart parking in accordance with an exemplary embodiment of the present invention is illustrated.

At step 1201, a plug-and-play point to multi point (PnP & P2MP) IoT platform is installed in each parking space and a parking arrangement. As described in FIG. 1-FIG. 9, each parking space (e.g., 812 to 814) in each parking structure 711-715, 721, 731, 732-1, 732-2, 733, and 741 is equipped with IoT sensor 821 and status pole 822. Depending on the structure and the total area of a parking lot, a group of IoT parking sensors 821 and status poles 822 are configured to communicate with a certain number of IoT managers (300-1 to 300-N). These IoT gateways communicate with one another via network 825 and allow IoT parking sensors 821 and status poles 822 to communicate the parking space data to one another in the disclosed PnP and P2MP manner. In many practical embodiments of step 1201, IoT devices 111-1-120-N are ultrasonic distance sensor model number HC-SR04 and IoT gateways 300-1 to 300-J are implemented with PnP configuration module 330 and P2MP module 340 as described above.

At step 1102, after the PnP&P2MP communication between each parking space and users has been established, the GPS metadata, the parking availability are embedded into the map of the parking environment. In more details, the maps of various parking environments similar to parking environment 700 in FIG. 7 had been created by various methods such as 3D scanning, geographic information system (GIS), ESRI database. Then GPS is embedded using JavaScript in Webservice. GPS metadata and location data are also embedded from MySQL to GIS server. Then parking availability of each parking space 811-814 is also displayed on the embedded map to create an interactive GPS parking map that includes flows of traffic 751-756 and exact location, speed, direction of each individual motorist 824.

At step 1103, the distribution of incoming flows of vehicles with respect to time and distance G(t, d) is established. When flows of traffic 751-756 and exact location, speed, direction of each individual user 802 in real-time are collected, the distribution function with respect to time and distance G(t, d) can be formulated. The distribution incoming flows of traffic G(t, d) can be uniform distribution, geometric distribution, and Poisson distribution. In many aspects of the present invention, when queues of arriving motorists are formed, the distribution G(t, d) is most likely uniform. Thus, the PnP&P2MP system of the present invention applied to the parking situation yields uniform distribution G(t, d).

At step 1104, the parking availability distribution function F(t+Δt) is calculated. Within preset time Δt, for example 30 minutes, many vehicles may leave their respective parking spaces, e.g., 811-814, in the preset time ΔT. At that time t, these parking spaces may not be available, but in t+Δt they may leave, creating more available parking spaces. IoT parking gateways 300-1 to 300-J collect these information and form distribution F(t+Δt). Then the total of number of available parking spaces in each of parking structures 711-741 can be calculated.

At step 1105, with the information from steps 1103-1104, batch arrival queues in multiserver queuing system M^{X}/M/m/n for each parking arrangement is formed. Example of step 1105 is the batch arrival queues in multiserver queuing system 1000 M^{X}/M/m/n is shown in FIG. 10, where m is the total number of users who are currently seeking parking, n is the total number of parking spaces available in time t+Δt. Δt is the cutoff time and preselected depending on the distribution function G(t, d). If the distribution function G(t, d) is a Poisson distribution with the average number of vehicles seeking for parking spaces in a certain time period Δt is known, the probability that a certain number of vehicles can be calculated. In some situation, Δt is set to zero. In others, Δt is set to 30 minutes.

At step 1206, the number of vehicles in each batch arrival queue (Lq), their locations, moving direction, and average velocity (V) of each vehicle are calculated using an arithmetic logic unit (ALU) of microprocessor 1014 in combination with GIS/GPS module 1030. Additionally, incoming flows of vehicles (Lq) who seeking parking is determined. Step 1208 is realized by user 903 communicating with IoT managers 300-1 to 300-J. The GPS coordinate location (x, y, z) and movement vector including speed and direction of each motorist 805 and each parking space 811-814 are collected and determined using GIS/GPS module 1030.

At step 1207, minimum waiting time for each user is calculated. From the queues in multiserver queuing system M^{X}/M/m/n model, minimum waiting time Wq for each user 824 who drives vehicle 805 parking availability of each parking space is exchanged among parking structures. In various aspects of the present invention, parking availability information in real-time is collected at either IoT managers 300-1 to 300-J to calculate minimum waiting time for each user 903 of vehicle 805. The detailed operation of step 1002 will described in method 1100 of FIG. 11.

At step 1208, incoming flows of vehicles (Lq) who seeking parking is determined. Step 1208 is realized by user 903 communicating with IoT managers 300-1 to 300-J. The GPS coordinate location (x, y, z) and movement vector including speed and direction of each motorist 805 and each parking space 811-814 are collected and determined using triangulation of GPS application. Each parking section 800 of parking structures 711-741 serves as a multiple server while each nearest traffic flows 751-756 forms queues 1111-1131. Therefore, in the long run throughput is calculated as Wq=(Lq/N) where Wq is the minimum searching time, Lq is a traffic flow that moves toward a nearest parking segment 800, and N is the total number of vehicles within that queue.

At step 1209, from the information of previous steps 1201-1208, the batch arrival queues, the locations of available parking spaces, the map of the area, the directions to the nearest available parking spaces are displayed. Step 1209 is realized by GIS/GPS module 1030, queueing formation engine 1000, and smart parking module 240.

Method 1200 of the present invention achieves the following objectives of the present invention:

(1) Reducing available parking searching time loss;

(2) Enhancing throughput for each parking structure, thus increasing profits; and

(3) Circumventing traffic congestions, benefiting the entire area including motorists who just drive by and do not look for parking spaces.

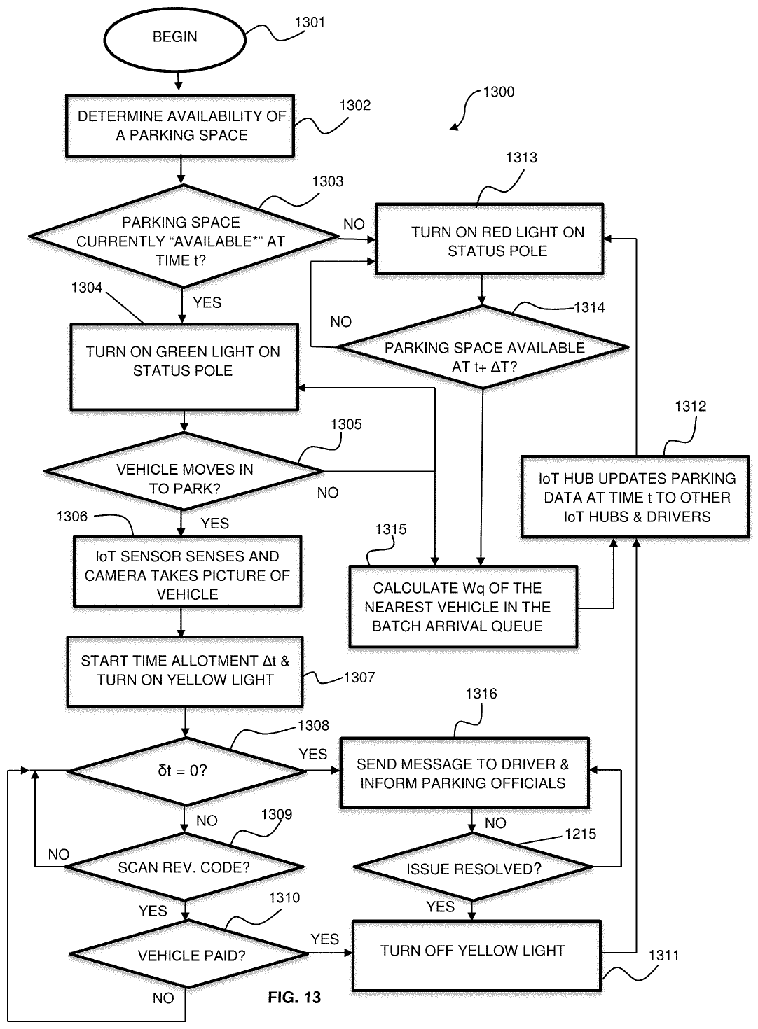

Referring now to FIG. 13, a flow chart of a method 1300 for a smart parking within a parking area in accordance with an exemplary embodiment of the present invention is illustrated.

At step 1301, method 1300 begins by installing the PnP&P2MP IoT system 100 including IoT server 210-1 and IoT gateway 300-1 to 300-J as described in FIG. 1 to FIG. 6. IoT devices 111-1 to 120-N are distance sensor or object detectors using various methods such as RF, ultrasounds (HC-SR04), infrared (IR), photoelectric LED sensors, etc.

At step 1302, the availability of each parking space is determined. As alluded above, step 1302 is realized by IoT devices 111-1 to 120-N being a distance sensor or object detector. IoT devices include IoT-based public communication means such as public digital signage and traffic lights.

At step 1303, the total number of parking spaces available at time t in all parking areas (N_{P}) is determined. Thep 1303 is realized by IoT devices 111-1 to 120-N and first adder 1011.

At step 1304, if a particular parking space is available or empty, a green light on status pole is turned on. Step 1304 is realized by status pole 912-942 and IoT devices 111-1 to 120-N. When IoT devices 111-1 to 120-N determines a particular parking is empty, it triggers the green light on status poles 912-942 located on each parking spaces 811-814.

Next at step 1305, whether a motorist is moved in to park is determined. Each IoT device 111-1 to 120-N being an ultrasonic sensor HC-SR04 operates at a range of 2 cm-4.5 cm.

At step 1306, if a motorist moves in to park, IoT devices will take picture of the license plate of the vehicle. Step 1306 is realized by an automatic camera installed in status pole 822 located either in front or in the back of vehicle 805 where the license plate is found.

At step 1307, the clock for parking duration or service time τ and preparation time δt start. Service time τ is the time duration that a motorist parks his car 805. Preparation time δt is the amount of time given to a motorist to pay for that particular parking space.

At step 1308, whether the preparation time δt is over. Step 1308 is realized by a clock inside status pole 822.

At time 1309, whether the reservation code is scanned is determined. Step 1309 is realized by a scanner inside status pole 822.

Continuing to step 1310, whether the parking space is paid for. If the answer to step 1309 and 1310 is NO, method 1300 goes back to step 1308 to check if the preparation time is over or δt=0. If the preparation time is zero and the answers to steps 1309 and 1310 are NO, then step 1316 is performed.

At step 1316, messages of non-compliance are sent to the motorists and the parking officials. In many aspects of the present invention, SMS messages 251 as described in FIG. 2 are sent to motorists 805.

Then at step 1317, whether the outstanding issues of non-payment and the confirmation of parking reservation have been resolved are determined. In other words, after the preparation time δt is over, motorists 805 are given another chance to resolve the issues.

Back to step 1311, if the issues are resolved either during the preparation time or after the non-compliance SMS messages are sent, the yellow light located at status pole 822 is turned off. Otherwise, the yellow light continues to stay ON.

At step 1312, the statuses of parking spaces at time t are exchanged between IoT gateways and IoT servers via a network. Step 1312 are realized by the PnP&P2MP IoT system 100 as described in FIG. 1 to FIG. 12 above.

At step 1313, if a parking space is not available, the red light on the status pole is turned on, signaling that this particular parking space is not available. This means, this particular parking space is not counted in the number of parking spaces available N_{P}.

At step 1314, whether parking spaces will be available in the preset time duration Δt is determined. The parking time or service time for each parking space is stored in parking data 231. Therefore, the average remaining time for each parking space is known. The preset time Δt can be selected to make more parking spaces or servers available in situation where the number of incoming motorists looking for available parking spaces is much greater than the number of available parking spaces at time t (N_{C}>>N_{P}).

Finally at step 1315, the minimum time to the nearest parking space for each motorist W_{q} is calculated. This minimum time W_{q} equals to the distance between the motorist and the nearest parking area which has available parking spaces divided by its velocity (V_{S}). Step 1315 is realized by GIS/GPS module 1030 and queueing model 1100.

Referring now to FIG. 14, a perspective view of a control webapp graphics user interface (GUI) 1400 applicable to the smart parking application in accordance with an exemplary embodiment of the present invention is illustrated. In many embodiments of the present invention, smart parking control webapp GUI 1400 is created by webapp configuration module 343 which receives virtual nodes, infrastructure, physical connections, communication protocols, industrial standards, and operating parameters information from connection firmware 341, communication protocol broker 316, and PnP API module 331.

In one particular embodiment of the present invention, control webapp GUI 1400 is displayed as a webapp on a computer screen of motorists 805. In other embodiments of the present invention, control webapp GUI 1400 can be displayed on a touchscreen of a smart phone 824 or on the dashboard of a vehicle 805.

Continuing with FIG. 14, in an exemplary embodiments of the present invention, control webapp GUI 1400 includes a login section 1401, a driving direction section 1420, GPS map section 1430, a parking information section 1440, and an additional data section 1450. Login section 1410 further includes a username window (or box) 1401 and an minimum waiting time or average time to parking (W_{Q}) 1402 to the nearest parking structure that has available parking spaces, and the address of the destination parking structure section 1403. Other methods of authentication such as scanning in barcodes, QR codes, RFID, or sending an authentication code to a registered email are also within the scope of the present invention.

Driving instruction section 1420 uses GIS/GPS module 243 and the minimum waiting time (W_{Q}) to provide driving instructions to the parking structure that has available parking spaces. Map section 1430 renders a map particular parking environment in a geographic area. Parking information section 1440 displays all the parking structures and the statuses of all parking spaces within the parking environment. As a non-limiting example, parking No. 1 701 represented by integration group 111 has a capacity of 6,000 parking spaces and has 3,165 available parking spaces at time t. Parking No. 2 702 represented by integration group 112, has a capacity of 500 parking spaces and now is completely full. Parking No. 1 703 represented by integration group 113 has a capacity of 2,000 parking spaces and has 500 available parking spaces at time t. Parking No. 4 704 represented by integration group 120 has a capacity of 300 parking spaces and has 200 available parking spaces at time t. A scrolling arrow 1441 enables motorists 805 to view other parking structures within the area. Finally, additional parking information section 1450 contains future available parking spaces within the preset time period Δt as parked motorists are leaving for each parking structure. The prices for each parking structure are also included and displayed. It is noted that other parking information can be included using control webapp module 243.

From the disclosures above as illustrated in FIG. 1-FIG. 14, the present invention achieves the following objectives:

An IoT parking environment that can achieve plug-and-play and point to multipoint communication for all IoT devices, IoT agents regardless of their industrial standards, physical connections, and communication protocols.

After connected to any pre-existing IoT environment, the IoT gateway and IoT server of the present invention are capable of rendering such pre-existing IoT environment into a plug-and-play and point-to-multipoint communication IoT parking environment.

A plug-and-play and point-to-multipoint platform that can provide real-time data of all parking information for the parking environment to increase the data analytics capability that can build a parking queueing model for a smart parking system and method that are based on minimal waiting time (W_{Q}) and maximum throughput that can avoid traffic congestions.

Computer program code for carrying out operations for aspects of the present invention such as PnP P2MP mapping module 340 or IoT environment management module 240 may be written in any combination of one or more programming languages, including an object oriented programming language such as Python, Object-Oriented Programming, Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The disclosed flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### DESCRIPTION OF NUMERALS

100 IoT environment such as a parking environment

101 a network such as internet, LAN, WAN, cloud/edge/fog

111 first integration group such as parking area 710

111-1 IoT device such as ultrasonic distance sensor HC-SR04

111-2 another IoT device

111-K an K^{th} IoT device

112 second integration group such as second parking area 720

112-1 IoT device such as ultrasonic distance sensor HC-SR04

112-2 a second IoT device of the second IoT agent

112-L an L^{th} IoT device of the second IoT agent

113 third integration group such as third parking area 730

113-1 first IoT sensor such as ultrasonic distance sensor HC-SR04

113-2 second IoT sensor

113-M M^{th} IoT sensor

120 fourth integration group such as fourth parking area 740

120-1 a first IoT device such as ultrasonic distance sensor HC-SR04

120-2 a second IoT device

120-N the N^{th} IoT device

131 connections in the first integration group 111

141 connections in the second integration group 112

151 connections in the integration group 113

161 connections in the integration group 120

171 connections between IoT agents and IoT server

200 IoT servers with deep reinforcement neural network (DRNN)

201 edge/fog/cloud network

202 communication channels between IoT agents and the network

203 communication channels between IoT agents

210-1 first IoT server

210-2 second IoT server

210-O O^{th} IoT server

211 microprocessor for IoT server

212 power supplies for the IoT server

213 network interface for the IoT server

214 ROM/RAM for the IoT server

215 I/O Interface

216 display device for the IoT server

217 keyboard device for the IoT server

218 audio interface for the IoT server

219 pointing device for the IoT server

220 memory device for the IoT server

221 O.S./BiOS for the IoT server

222 data storage

230 data repository for the IoT server

231 parking data

232 GIS/GPS data

240 smart parking ASM

241 webapp configuration module

242 gateway manager

243 actuator interface

244 switching Network

250 deep reinforcement neural network (DRNN)

260 smart parking module

261 GIS/GPS module

262 queue formation engine

271 SMS message from IoT server to the client device

272 client devices including laptops, computers, mobile devices

300 architecture of the IoT parking gateway

300-1 first IoT agent

300-2 second IoT agent

300-J J^{th} IoT agent

301 microprocessor of the IoT agent

302 electrical connections

310 power supply

311 CMOS backup battery

312 EEPROM/Flash memories

313 SIM slot

314 GPS unit

315 external connections manager

315 communication protocol broker

316 virtual map module

318 switching Network

319 external connection manager

320 memory

321 Operating System (OS)

322 parking data

330 PnP configuration module

331 PnP API

332 IoT device driver module

340 PnP and P2MP module

341 connection firmware

342 IoT sensor controller

343 webapp configuration module

500 WebApp display page

501 pointing device, e.g., cursor

510 authorization section

511 username

512 password/QR scan

520 IoT device Reading Section

521 IoT agent Selector

522 IoT device Selector

530 Point to Multipoint connection setup section

531 first IoT agent selector

51-1 IoT device 111-1

531-N IoT device 111-K

531-M drop down menu

532 second IoT agent selector

532-1 IoT device 112-1

532-2 IoT device 112-2

532-N IoT device

533 M^{th} IoT agent selector

533-1 IoT device 120-1

533-2 IoT device 120-2

533-N IoT device 120-N

540 IoT server set up

541 IoT server ID

541-M Dropdown list of all active IoT servers

542 AI mode ON/OFF

543 Communication channel of current IoT server

550 IoT agent set up

551 IoT agent ID

552 Plug-and-play mode ON/OFF

553 communication channel of current IoT agent

560 IoT device set up

561 IoT device set up mode ON/OFF

562 add/Remove operational parameters

563 IoT device's parameter toggle

563-M IoT device parameters drop-down menu.

700 parking environment

701 main street such as Nguyen Dinh Chieu St.

702 first cross street

703 second cross street

710 first parking area (structure or arrangement)

711 multi-storied parking structure

711¹-11 a (1, 1, 1) parking space of first parking structure

711¹-1L an (1, 1, L) parking space of the first parking structure

711²-KL an (2, K, L) parking space

711^{N}-K1 an (N, K, 1) parking space

711^{N}-K1 an (N, K, 1) parking space

711^{N}-K2 an (N, K, 2) parking space

711^{N}-KL an (N, K, L) parking space

712 first shopping building

712-1 first outdoor parking structure

713 second shopping building

713-1 second outdoor parking structure

714 third shopping building

714-1 third outdoor parking structure

715 fourth shopping building

715-1 fourth outdoor parking structure

720 second parking area

721 public parking structure

722 mansion or villa

730 third parking area

731 high-rise condos

732-1 first level underground parking structure

732-2 second level underground parking structure

733 ground level parking structure

740 fourth parking area

741 open parking structure

751 first traffic flow on the main street

752 second traffic flow opposite to first traffic flow

753 third traffic flow on the first cross street

754 fourth traffic flow opposite to third traffic flow

755 fifth traffic flow on the second cross street

756 sixth traffic flow opposite to fifth traffic flow

800 inside a parking structure i.e., 711

801 main drive way

802 sidewalk

803 light poles

805 vehicles

812 a parking space

813 a parking space

814 a parking space

820 smart parking equipment

821 IoT sensor

822 status pole

823 IoT gateway

901 network in parking arrangements

902 parking central server

903 motorists' smart phones or display panels

910 first parking arrangement

911 IoT sensor in first parking arrangement

912 status pole in first parking arrangement

913 IoT agent in first parking arrangement

920 second parking arrangement

921 IoT sensor in second parking arrangement

922 status pole in second parking arrangement

923 IoT agent in second parking arrangement

930 third parking arrangement

931 IoT sensor in third parking arrangement

932 status pole in third parking arrangement

933 IoT agent in third parking arrangement

940 fourth parking arrangement

911 IoT sensor in fourth parking arrangement

912 status pole in fourth parking arrangement

913 IoT agent in fourth parking arrangement

1000 queue formulation engine

1010 ALU

1011 first adder/summation

1012 second adder

1013 comparator

1014 logic unit

1020 memory bank

1021 M₀ first memory storage

1022 M₁ second memory storage

1023 M₂ third memory storage

1024 M_{N} N^{th} memory storage

1030 GIS/GPS module

1040 queue arbitration logic

1100 multiserver queuing system

1101 first queue model for first parking area

1102 second queue model for second parking area

1103 third queue model for third parking area

1104 fourth queue model for fourth parking area

1111 first queue for first traffic flow

1112 second queue for third traffic flow

1113 third queue for fourth traffic flow

1121 fourth queue for fifth traffic flow

1122 fifth queue for sixth traffic flow

1123 output queue for third parking area

1131 sixth queue for second traffic flow

1132 output queue for fourth parking area

1400 GUI control webapp for smart parking

1410 login or authentication area

1401 username of motorist

1402 average time W_{q} to parking display window

1403 current location of motorist

1420 Driving direction to nearest parking structure

1430 parking statuses of parking spaces in the area

1431 first parking area

1432 total parking capacity/available of first parking area

1433 status of individual parking space

1431-2 second parking area

1432-2 total parking capacity/available of second parking area

1433-2 status of individual parking space in second parking area

1431-N N^{th} parking area

1432-N total parking capacity/available of N^{th} parking area

1433-N status of individual parking space in N^{th} parking area

1440 parking information section

1441 available parking spaces in 30′ for first parking area

1442 price for first parking area

1441-2 available parking spaces in 30′ for second parking area

1442-2 price per day for second parking area

1441-N available parking spaces in 30′ for N^{th} parking area

1442-N price per day for N^{th} parking area

What is claimed is:

1. A smart parking system, comprising:
a network;
a plurality of IoT servers coupled together and serviced by said network, wherein each of said IoT servers is operable to receive parking information and operate said parking system;
a plurality of IoT gateways coupled to communicate with said plurality of IoT servers;
a plurality of IoT sensors, electrically coupled to communicate with said plurality of IoT gateways, wherein each of said plurality of IoT sensors is installed to detect a presence of a vehicle in a parking space; and
a plurality of status columns, electrically coupled to communicate with said plurality of said IoT sensors; wherein each of said plurality of IoT gateways is operable to provide plug-and-play and point to multipoint communication so as to exchange parking information from said plurality of gateways, said plurality of status columns, a plurality of motorists who are seeking for parking spaces, IoT-based public communication means, and said plurality of IoT sensors; and wherein each of said plurality of IoT servers is operable to receive said parking information to form a queueing model for a parking situation; wherein said queuing model is formed according to a minimum waiting time (W_{Q}) to an parking structure that has available parking spaces for motorists.

2. The smart parking system of claim 1 wherein each of said plurality of status columns is installed next to each of said parking spaces and further comprises:
a first light, electrically coupled to one of said plurality of IoT sensors, operative to turn on when said IoT sensor detects that said parking space is occupied by a vehicle;
a second light, electrically coupled to said one of said plurality of IoT sensors, operative to turn on when said IoT sensor detects that said parking space is empty; and
a third light, electrically coupled to said one of said plurality of IoT sensors, operative to turn on when said motorist parks said vehicle off to said parking space by an offset distance δd and when said motorist fails to confirm a parking preservation and/or fails to pay for said parking preservation within an allotment of time δt.

3. The smart parking system of claim 2 wherein each of said plurality of status columns further comprises automatic payment means for said motorist to pay for said parking space either at said plurality of status columns or electronically via said network.

4. The smart parking system of claim 3 wherein each of said plurality of status columns further comprises an automatic camera operative to take a picture of a license plate of said vehicle which is successfully parked in said parking space and when said third light is turned off and said first light is turned on.

5. The smart parking system of claim 1 wherein each of said plurality of servers further comprises a smart parking module further comprising:
a control webapp configuration module configured to receive said parking information from said plurality of gateways to create a control webapp graphic user interface (GUI) for said motorists to preserve, to pay, to confirm, and to follow driving instructions to one of said parking spaces; and
a geographic information system (GIS) module configured to render a map with geographic parameters of said parking situation of a parking environment in an geographical area which comprises a plurality of parking structures.

6. The smart parking system of claim 5 wherein said smart parking module further comprises:
a queue formation engine, in communication with said plurality of IoT sensors, said plurality of gateways, and said plurality of said servers, configured to receive said parking information and said geographic parameters to form said queueing model of said parking situation at a time t, wherein said queueing model comprises said plurality of motorists as batch arriving queues and said plurality of parking structures that have available parking spaces at time t as multiservers.

7. The smart parking system of claim 6 wherein said queue formation engine further comprises:
an arithmetic logic unit (ALU) configured to receive said parking information from said plurality of IoT sensors and said geographic parameters from said GIS to calculate said minimum waiting time (W_{Q}) for each of said motorists;
a plurality of memory banks, coupled to said ALU, configured to store said arriving queues in accordance with said minimum waiting time (W_{Q}) for each of said motorists; and
a queue arbitration logic; coupled to said plurality of memory banks, said GIS module, and said plurality of IoT devices; configured to decide a number of said motorists in said batch arriving queues based on the availability of said plurality of parking spaces and said minimum waiting time (W_{Q}) for each of said motorists.

8. The smart parking system of claim 7 wherein said ALU further comprises:
a first adder, configured to receive said parking information from said plurality of parking spaces, and to add up a total number of available parking spaces (N_{P}) at time t;
a second adder, configured to receive parking requests from said plurality of motorists and to add up a total number of said motorists in said batch arriving queues who are seeking for said available parking spaces (N_{C}); and
a comparator, coupled to said first adder and said second adder, configured to compare said total number of said motorists in said batch arriving queues who are seeking for said available parking spaces (N_{C}) versus said total number of available parking spaces (N_{P}).

9. The smart parking system of claim 8 wherein said ALU further comprises a microcontroller in communication with said GIS module and said comparator, configured to calculate said minimal waiting time (W_{Q}) and decide to form said batch arriving queues when said total number of said motorists in said arriving queues who are seeking for said available parking spaces (N_{C}) is substantially greater than said total number of available parking spaces (N_{C}>>N_{P}).

10. The smart parking system of claim 9 wherein said microcontroller, upon receiving said parking information from said plurality of IoT sensors, is configured to calculate a number of available parking spaces will be available within a preset amount of time Δt, and adjust said total number of said motorists of said batch arriving queue.

11. The smart parking system of claim 10 wherein said plurality of IoT gateways each further comprises a plug-and-play module configured to:
(a) detect whether said plurality of IoT sensors, said plurality of IoT gateways, and/or said plurality of IoT servers each is included in said control webapp GUI;
(b) if said plurality of IoT sensors, said plurality of IoT gateways, and/or said plurality of IoT servers each is included in said control webapp GUI, then control said plurality of IoT sensors, said plurality of IoT gateways, and/or said plurality of IoT servers in said plug-and-play manner and said point to multipoint manner in accordance with setups and instructions of said control webapp module; otherwise,
(c) if any of said plurality of IoT sensors, said plurality of IoT gateways, and/or said plurality of IoT servers are not included in said control webapp, then detect said operating parameters, said physical connections, said communication protocols, and said industrial standards using a plug-and-play application program interface (API) and then use said webapp configuration module to insert said operational parameters, said communication protocols, and said industrial standards into said control webapp module which is configured to create said plug-and-play manner and said point-to multipoint manner for each of said said plurality of IoT sensors, said plurality of IoT gateways, and/or said plurality of IoT servers.

12. The smart parking system of claim 11 wherein each of said at least one IoT gateways further comprises a connections firmware configured to detect and connect said plurality of IoT sensors, said plurality of IoT gateways, said plurality of IoT servers regardless of said physical connections; wherein said physical connections comprises a Zwave connection, a Zigbee connections, a Bluetooth connection, an Ethernet connection, a wifi connection, a cellular connection using a SIM, a LORA connection, a near field communication (NFC) connection; wherein said communication protocols comprise a HTTP protocol, a websocket protocol, a MQTT protocol.

13. The smart parking system of claim 12 wherein said connections firmware further comprise
a detector to detect an operating frequency, said operating parameters, and said industrial standards of each of said plurality of IoT devices, said plurality of IoT managers, and said plurality of IoT servers; and
a driving circuit and a switching network to adaptively set up said physical connections among said plurality of IoT devices, said plurality of IoT managers, and said plurality of IoT servers by retrieving a device driver from a memory and loading said device driver into said driving circuits based on results from said step of detecting said operating frequency, said operating parameters, and said industrial standards.

14. The smart parking system of claim 13 wherein said detector comprises a barcode scanner, a QR code scanner, an infrared scanner, and an RFID reader.

15. The smart parking system of claim 14 wherein said control webapp GUI is configured to facilitate online preservation, payments for said parking spaces, a view of said traffic situation within said parking environment.

16. A method of achieving a smart parking system, comprising:
(a) detect a physical connection for each of said plurality of IoT devices, a plurality of IoT managers, and a plurality of IoT servers;
(b) detect a communication protocol for each of said plurality of IoT parking sensors, a plurality of IoT gateways, and a plurality of IoT servers;
(c) establish a plug-and-play communication with said plurality of IoT parking sensors, a plurality of IoT gateways, and a plurality of IoT servers based on said physical connection, said industrial standards, and said communication protocols;
(d) determine whether each of said plurality of IoT parking sensors, said plurality of IoT gateways, and said plurality of IoT servers is incorporated in a control webapp graphic user interface (GUI), if said plurality of IoT parking sensors, said plurality of IoT gateways, and said plurality of IoT servers are included said control webapp GUI, then
(e) use said control webapp GUI to create a point to multipoint communication and plug-and-play environment for said plurality of IoT parking sensors, said plurality of IoT gateways, a plurality of motorists seeking for available parking spaces, IoT-based public communication means, and said plurality of IoT servers;
(f) receive parking information from said plurality of parking sensors, said plurality of IoT gateways, said plurality of IoT servers;
(g) receive a total number of arriving motorists who are searching for available parking spaces (N_{C});
(h) form a parking queueing model based on said parking information and said total number of arriving motorists wherein said parking queueing model further comprise said arriving motorists as batch arrival queues and said available parking spaces as servers, and
(i) calculate a minimal waiting time (W_{Q}) to a nearest parking structures that have said available parking spaces.

17. The process of claim 16 further comprising:
(j) calculate a total number of said motorists who will leave said parking spaces within a present time Δt in the future; and
(k) adjust a length of said queuing model in accordance with said total number of said parking spaces available in said preset time Δt.

18. The process of claim 17 further comprising:
(l) open said control webapp GUI;
(m) log in and complete an authorization process;
(n) set up said control webapp GUI for said point to multipoint communication by switching corresponding on/off software buttons in a dropdown menu, each of said software buttons is associated with said plurality of IoT parking sensors and said plurality of IoT gateways;
(o) view a parking situation that displays said available parking spaces with a parking structure in a parking environment; and
(p) preserve and pay for a parking space online.

19. The process of claim 18 further comprising:
(q) turn on red lights when said parking spaces are occupied;
(p) turn on green lights when said parking spaces are available; and
(q) turn on a yellow lights when said motorists park said vehicles skewed off from said parking spaces and said motorists fail to confirm said preservation and payment within an allotment time δt.

20. The process of claim 19 wherein said queueing model is not formed when said total number of said motorists who are seeking for available parking spaces (N_{C}) is substantially smaller than said total number of available parking spaces (N_{P}).
